(19) United States
(12) Patent Application Publication
(10) Pub. No.: US 2024/0359438 A1
(43) Pub. Date: Oct. 31, 2024

(54) MULTILAYERED BIODEGRADABLE FILM, METHOD FOR MANUFACTURING SAME, AND ECO-FRIENDLY PACKAGING MATERIAL COMPRISING SAME

(71) Applicant: SK MICROWORKS CO., LTD., Gyeonggi-do (KR)

(72) Inventors: Seokin LEE, Gyeonggi-do (KR); Kweon Hyung HAN, Gyeonggi-do (KR)

(21) Appl. No.: 18/683,249

(22) PCT Filed: Sep. 1, 2022
(86) PCT No.: PCT/KR2022/013133

§ 371 Date: Feb. 13, 2024

(30) Foreign Application Priority Data
Sep. 15, 2021 (KR) 10-2021-0123507

(51) Int. Cl. B32B 27/08; B32B 7/027; B32B 27/36; B32B 37/15; B32B 38/00

(52) U.S. Cl. CPC B32B 27/08; B32B 7/027; B32B 27/36; B32B 37/153; B32B 38/0004; B32B 38/0012; B32B 38/0036; B32B 2038/0028; B32B 2250/05; B32B 2250/244; B32B 2250/42; B32B 2307/518; B32B 2307/7163; B32B 2307/7376; B32B 2367/00

(57) ABSTRACT

The present invention provides a multilayered biodegradable film, a method for manufacturing same, and an eco-friendly packaging material comprising same. Specifically, the multilayered biodegradable film comprises two or more kinds of different thermoplastic resin layers, which are alternately laminated and include: a first resin layer containing as a main ingredient a polylactic acid-based polymer; and a second resin layer containing as a main ingredient an aliphatic polyester-based resin or an aliphatic-aromatic copolymer polyester-based resin, the uniformity (LUI) of the first resin layer being adjusted to 0.2 μm or less. Therefore, the multilayered biodegradable film retains excellent biodegradability and can improve the uniformity, flexibility, transparency, external appearance characteristics, and degrees of noise of final films, and thus can be utilized as a packaging material in various fields to enable the provision of a high-quality, eco-friendly packaging material.

### TECHNICAL FIELD

The present invention relates to a multilayer biodegradable film, to a process for preparing the same, and to an environmentally friendly packaging material comprising the same.

### BACKGROUND ART

Plastic films commonly used for packaging purposes include cellophane, polyvinyl chloride (PVC), polyethylene (PE), polypropylene (PP), nylon, and polyethylene terephthalate (PET).

However, cellophane films cause severe environmental pollution during the preparation process; thus, their production is subject to a lot of regulations. Polyvinyl chloride films generate harmful substances such as dioxin when incinerated; thus, their use is subject to a lot of regulations. In addition, polyethylene films lack thermal resistance and mechanical properties; thus, their use is limited except for low-quality packaging purposes. Polypropylene, nylon, and polyethylene terephthalate have relatively stable molecular structures and good mechanical properties. However, when they are used for packaging purposes and then landfilled without special treatment, they are hardly decomposed due to their chemical and biological stability and accumulate in the ground, thereby shortening the lifespan of the landfill and causing the problem of soil contamination.

To make up for the shortcomings of these non-degradable plastic films, polylactic acid films, which are aliphatic polyesters with high biodegradability of the resin itself, have been widely used in recent years. Although these films have good mechanical properties, their use is limited due to the lack of flexibility due to the unique crystal structure.

To improve this problem, Japanese Laid-open Patent Publication No. 2006-272712 discloses a method of preparing a film using a biodegradable aliphatic polyester alone other than polylactic acid. In such a case, not only is the glass transition temperature so low that it is not easy to prepare a film using a biaxial stretching method, but also the mechanical strength of a final film is low and the heat shrinkage rate is high, causing many problems during the processing thereof.

Meanwhile, Japanese Laid-open Patent Publication No. 2003-160202 discloses a method of blending polylactic acid with an aliphatic-aromatic copolymerized polyester to impart flexibility and heat-sealing properties to a film. However, there is a problem with this method in that the transparency of a final film is significantly reduced due to the low compatibility between polylactic acid and the aliphatic-aromatic copolymerized polyester and the use of a plasticizer, making it difficult to be used in packaging applications that require transparency.

In addition, when a multilayer film containing a polylactic acid and an aliphatic-aromatic copolymerized polyester is formed under specific extrusion temperature conditions, the deviation in layer uniformity by location is large, making it difficult to control the film appearance and thickness. If the uniformity varies greatly from location to location, marks or defects in the layer are likely to occur, which may adversely affect the physical properties of the film, and thickness control may be difficult, resulting in problems with processability, productivity, and moldability.

### PRIOR ART DOCUMENT

### [Patent Document]

(Patent Document 1) Japanese Laid-open Patent Publication No. 2006-272712
(Patent Document 2) Japanese Laid-open Patent Publication No. 2003-160202

### DISCLOSURE OF INVENTION

### Technical Problem

An object of the present invention is to provide a multilayer biodegradable sheet or film in which the layer uniformity of the multilayer biodegradable film is adjusted such that the flexibility, transparency, noise level, and appearance characteristics of the film are simultaneously improved.

Another object of the present invention is to provide a process for preparing a multilayer biodegradable film that can satisfy all of the above properties desired in the present invention in which the melt viscosity range of the first resin layer and that of the second resin layer are efficiently controlled in order to adjust the uniformity (LUI; layer uniformity index) of the first resin layers of the multilayer biodegradable sheet or film to an optimal range, and the thickness of each layer is finely adjusted.

Another object of the present invention is to provide a high-quality, environmentally friendly packaging material that is biodegradable and environmentally friendly by using the multilayer biodegradable film with controlled uniformity.

### Solution to Problem

The present invention provides a multilayer biodegradable film that comprises two or more different thermoplastic resin layers alternately laminated, wherein the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUI) of the first resin layers, represented by the following Equation 1, is 0.2 μm or less:

$$L U I ( µm ) = \frac{\begin{matrix}( {t}_{m ax , N} - {t}_{m i n , N} ) + ( {t}_{ma x , C} - \\ {t}_{m i n , C} ) + ( {t}_{ma x , S} - {t}_{m i n , S} )\end{matrix}}{3} \qquad < Equation 1 >$$

In Equation 1, when the multilayer biodegradable film having a width of 500 mm and a thickness of 20 to 25 μm is cut in the thickness direction along a point (N) 50 mm away from one end in the transverse direction, a point (S) 50 mm away from the other end in the transverse direction, and a central point (C) in the transverse direction, and when the thicknesses of the individual layers, excluding the outermost layers on both sides, of the laminated first resin layers are measured using a field emission scanning electron microscope (FE-SEM) on the cross-section,

t_{max, N} is the maximum thickness of the thicknesses of the individual layers, excluding the outermost layers on both sides, of the first resin layers measured at point N of the multilayer biodegradable film,

t_{min, N} is the minimum thickness of the thicknesses of the individual layers, excluding the outermost layers on both sides, of the first resin layers measured at point N of the multilayer biodegradable film,

t_{max, S} is the maximum thickness of the thicknesses of the individual layers, excluding the outermost layers on both sides, of the first resin layers measured at point S of the multilayer biodegradable film,

t_{min, S} is the minimum thickness of the thicknesses of the individual layers, excluding the outermost layers on both sides, of the first resin layers measured at point S of the multilayer biodegradable film,

t_{max, C} is the maximum thickness of the thicknesses of the individual layers, excluding the outermost layers on both sides, of the first resin layers measured at point C of the multilayer biodegradable film, and

t_{min, C} is the minimum thickness of the thicknesses of the individual layers, excluding the outermost layers on both sides, of the first resin layers measured at point C of the multilayer biodegradable film.

In addition, the present invention provides a multilayer biodegradable sheet that comprises two or more different thermoplastic resin layers alternately laminated, wherein the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUIₛ) of the first resin layers, represented by the following Equation 1-1, is less than 2.3 μm:

$$L U Is ( µm ) = \frac{\begin{matrix}( {t}_{ma x , N 1} - {t}_{m i n , N 1} ) + ( {t}_{m ax , C 1} - \\ {t}_{m i n , C 1} ) + ( {t}_{m ax , S 1} - {t}_{m i n , S 1} )\end{matrix}}{3} \qquad < Equation 1 - 1 >$$

In Equation 1-1, when the multilayer biodegradable sheet having a width of 650 mm and a thickness of 300 μm is cut in the thickness direction along a point (N) 50 mm away from one end in the transverse direction, a point (S) 50 mm away from the other end in the transverse direction, and a central point (C) in the transverse direction, and when the thicknesses of the individual layers of the laminated first resin layers are measured using a field emission scanning electron microscope (FE-SEM) on the cross-section,

t_{max, N1} is the maximum thickness of the thicknesses of the individual layers, excluding the outermost layers on both sides, of the first resin layers measured at point N of the multilayer biodegradable sheet,

t_{min, N1} is the minimum thickness of the thicknesses of the individual layers, excluding the outermost layers on both sides, of the first resin layers measured at point N of the multilayer biodegradable sheet,

t_{max, S1} is the maximum thickness of the thicknesses of the individual layers, excluding the outermost layers on both sides, of the first resin layers measured at point S of the multilayer biodegradable sheet,

t_{min, S1} is the minimum thickness of the thicknesses of the individual layers, excluding the outermost layers on both sides, of the first resin layers measured at point S of the multilayer biodegradable sheet,

t_{max, C1} is the maximum thickness of the thicknesses of the individual layers, excluding the outermost layers on both sides, of the first resin layers measured at point C of the multilayer biodegradable sheet, and

t_{min, C1} is the minimum thickness of the thicknesses of the individual layers, excluding the outermost layers on both sides, of the first resin layers measured at point C of the multilayer biodegradable sheet.

In addition, the present invention provides a process for preparing a multilayer biodegradable film that comprises preparing a first resin comprising a polylactic acid-based polymer as a main component and a second resin comprising an aliphatic polyester-based resin or an aliphatic-aromatic copolymerized polyester-based resin as a main component, respectively (step 1); melt-extruding the first resin and the second resin, respectively, and alternately laminating a first resin layer and a second resin layer to obtain a sheet in which two or more different types of thermoplastic resin layers are alternately laminated (step 2); and biaxially stretching and heat setting the laminated sheet to obtain a multilayer biodegradable film (step 3), wherein the uniformity (LUI) of the first resin layers in the multilayer biodegradable film is 0.2 μm or less as represented by the above Equation 1.

Further, the present invention provides an environmentally friendly packaging material that comprises the above multilayer biodegradable film.

### Advantageous Effects of Invention

The multilayer biodegradable film according to the present invention can have excellent uniformity, flexibility, and transparency at the same time, while improving appearance characteristics and noise level. In particular, the multilayer biodegradable film is characterized by having a small deviation in thickness by location and can achieve uniformity within a specific range.

In addition, the process for preparing a multilayer biodegradable film according to an embodiment can further enhance moldability, processability, and productivity in an economical and efficient way. In particular, as the melting temperature of a first resin, that of a second resin, and the difference between the melting temperatures are controlled, the melt viscosity range of the first resin layer and that of the second resin layer can be efficiently controlled. As a result, the thickness of each layer by location is finely controlled, whereby the uniformity (LUI) of the first resin layers of the multilayer biodegradable film can be adjusted to an optimal range.

Further, the multilayer biodegradable film is biodegradable, along with the above characteristics, and has environmentally friendly features as it completely decomposes when landfilled; thus, it can be used in various fields as a packaging material to provide a high-quality, environmentally friendly packaging material.

### BRIEF DESCRIPTION OF DRAWINGS

FIG. 1 is a schematic diagram of a multilayer biodegradable film according to an embodiment of the present invention.

FIG. 2 is a perspective view of a multilayer biodegradable film according to another embodiment of the present invention.

FIG. 3 shows a perspective view (a) cut along line A-A′ in FIG. 2 and an enlarged cross-section view (b) thereof.

FIG. 4 schematically shows the process of preparing a multilayer biodegradable film according to an embodiment of the present invention.

### BEST MODE FOR CARRYING OUT THE INVENTION

Hereinafter, the present invention will be described in more detail.

The embodiments are not limited to those described below. Rather, they can be modified into various forms as long as the gist of the invention is not altered.

Throughout the present specification, when a part is referred to as “comprising” an element, it is understood that other elements may be comprised, rather than other elements are excluded, unless specifically stated otherwise.

In the present specification, a singular expression is interpreted to cover a singular or plural number that is interpreted in context unless otherwise specified.

In addition, all numbers expressing the physical properties, dimensions, reaction conditions, and the like of elements used herein are to be understood as being modified by the term “about” unless otherwise indicated.

Throughout the present specification, the terms first resin layer, second resin layer, or first, second, and the like are used to describe various components. But the components should not be limited by the terms. The terms are used only for the purpose of distinguishing one component from another.

In addition, the references for “one side” and “the other side” or “on” and “under” of each component are explained based on the drawings. These terms are only for distinguishing components and may be interchanged with each other in actual application.

In the present specification, in the case where an element is mentioned to be formed “on” or “under” another element, it means not only that one element is directly formed “on” or “under” another element, but also that one element is indirectly formed on or under another element with other element(s) interposed between them.

In addition, for the sake of description, the sizes of individual elements in the appended drawings may be exaggeratedly depicted and do not indicate the actual sizes. In addition, the same reference numerals refer to the same elements throughout the specification.

In an embodiment, there is provided a multilayer biodegradable film, which comprises two or more different thermoplastic resin layers alternately laminated, wherein the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUI) of the first resin layers, represented by the following Equation 1, is 0.2 μm or less:

$$L U I ( µm ) = \frac{\begin{matrix}( {t}_{ma x , N} - {t}_{m i n , N} ) + ( {t}_{ma x , C} - \\ {t}_{m i n , C} ) + ( {t}_{ma x , S} - {t}_{m i n , S} )\end{matrix}}{3} \qquad < Equation 1 >$$

In Equation 1, when the multilayer biodegradable film having a width of 500 mm and a thickness of 20 to 25 μm is cut in the thickness direction along a point (N) 50 mm away from one end in the transverse direction, a point (S) 50 mm away from the other end in the transverse direction, and a central point (C) in the transverse direction, and when the thicknesses of the individual layers, excluding the outermost layers on both sides, of the laminated first resin layers are measured using a field emission scanning electron microscope (FE-SEM) on the cross-section,

t_{max, N} is the maximum thickness of the thicknesses of the individual layers, excluding the outermost layers on both sides, of the first resin layers measured at point N of the multilayer biodegradable film,

t_{min, N} is the minimum thickness of the thicknesses of the individual layers, excluding the outermost layers on both sides, of the first resin layers measured at point N of the multilayer biodegradable film,

t_{max, S} is the maximum thickness of the thicknesses of the individual layers, excluding the outermost layers on both sides, of the first resin layers measured at point S of the multilayer biodegradable film,

t_{min, S} is the minimum thickness of the thicknesses of the individual layers, excluding the outermost layers on both sides, of the first resin layers measured at point S of the multilayer biodegradable film,

t_{max, C} is the maximum thickness of the thicknesses of the individual layers, excluding the outermost layers on both sides, of the first resin layers measured at point C of the multilayer biodegradable film, and

t_{min, C} is the minimum thickness of the thicknesses of the individual layers, excluding the outermost layers on both sides, of the first resin layers measured at point C of the multilayer biodegradable film.

In an embodiment, it is possible to provide a multilayer biodegradable film that has excellent uniformity, flexibility, and transparency while improved in appearance characteristics and noise level, in which two or more different thermoplastic resin layers comprising a first resin layer and a second resin layer each having the specific composition are alternately laminated, and, in particular, the uniformity (LUI) of the first resin layers is adjusted to 0.2 μm or less.

Further, the multilayer biodegradable film is biodegradable, along with the above characteristics, and has environmentally friendly features as it completely decomposes when landfilled; thus, it has technical significance in that it can be used in various fields to exhibit excellent characteristics.

### [Multilayer Biodegradable Film]

Referring to FIG. 1, the multilayer biodegradable film (100) according to an embodiment of the present invention comprises two or more different thermoplastic resin layers alternately laminated, wherein the thermoplastic resin layers comprise a first resin layer (110) comprising a polylactic acid-based polymer as a main component and a second resin layer (120) comprising an aliphatic polyester-based resin or an aliphatic-aromatic copolymerized polyester-based resin as a main component. In addition, the multilayer biodegradable film (100) may comprise a first resin layer (110′) as an outermost layer on both sides. Specifically, the outermost layers on both sides of the multilayer biodegradable film are first resin layers (110′).

In an embodiment, as two or more different thermoplastic resin layers are alternately laminated, wherein the thermoplastic resin layers comprise a first resin layer and a second resin layer each having the specific composition, specifically, a first resin layer comprising a polylactic acid-based polymer as a main component and a second resin layer comprising an aliphatic polyester-based resin or an aliphatic-aromatic copolymerized polyester-based resin as a main component and laminated on one side of the first resin layer, not only can flexibility be enhanced and noise level be reduced, but interlayer adhesion characteristics can be enhanced by virtue of good interlayer compatibility between the first resin layer and the second resin layer, and moldability, processability, and productivity can be further enhanced.

Hereinafter, each layer of the multilayer biodegradable film will be described in detail.

### First Resin Layer

According to an embodiment, the first resin layer may comprise a polylactic acid (PLA)-based polymer as a main component.

In the present invention, the “main component” means that the proportion of a specific component among the entire components is 50% by weight or more. Specifically, it may mean 80% by weight or more, 85% by weight or more, 90% by weight or more, 95% by weight or more, 96% by weight or more, 97% by weight or more, or 98% by weight or more.

Specifically, the polylactic acid-based polymer may be employed in an amount of 50% by weight or more, specifically, 80% by weight or more, 85% by weight or more, 90% by weight or more, 95% by weight or more, 96% by weight or more, 97% by weight or more, or 98% by weight or more, based on the total weight of the first resin layer.

Since the polylactic acid-based polymer, unlike petroleum-based resins, is based on biomass, renewable resources can be used. It emits less carbon dioxide, the main cause of global warming, during its production as compared with conventional resins and is environmentally friendly as it is biodegraded by moisture and microorganisms when landfilled.

The polylactic acid-based polymer may have a weight average molecular weight (Mw) of 100,000 to 1,000,000 g/mole, for example, 100,000 to 800,000 g/mole, 100,000 to 500,000 g/mole, or 100,000 to 300,000 g/mole. The weight average molecular weight (Mw) may be measured by gel permeation chromatography (GPC). When the weight average molecular weight (Mw) of the polylactic acid-based polymer satisfies the above range, the mechanical and optical properties of the multilayer biodegradable film can be further enhanced.

The polylactic acid-based polymer may comprise L-lactic acid, D-lactic acid, D,L-lactic acid, or a combination thereof. Specifically, the polylactic acid-based polymer may be a random copolymer of L-lactic acid and D-lactic acid. Here, the content of D-lactic acid may be, for example, 1% by weight to 5% by weight, for example, 1% by weight to 4% by weight, for example, 1% by weight to 3% by weight, for example, 1% by weight to 2.5% by weight, or, for example, 1% by weight to 2% by weight, based on the total weight of the polylactic acid-based polymer. If the content of D-lactic acid satisfies the above range, it may be advantageous from the viewpoint of enhancement in film stretching processability.

The content of L-lactic acid may be, for example, 80% by weight to 99% by weight, for example, 83% by weight to 99% by weight, or, for example, 85% by weight to 99% by weight, based on the total weight of the polylactic acid-based polymer. If the content of L-lactic acid satisfies the above range, it may be advantageous from the viewpoint of enhancement in the thermal resistance properties of a film.

Meanwhile, according to an embodiment, the first resin layer may comprise a polylactic acid-based polymer, which is an aliphatic polyester, alone.

According to another embodiment, the first resin layer may comprise a resin obtained by copolymerizing a polylactic acid-based polymer with a small amount of another hydroxy carboxylic acid unit. In such an event, examples of the hydroxy carboxylic acid unit include glycolic acid or 2-hydroxy-3,3-dimethylbutyric acid. The hydroxy carboxylic acid unit may be employed in an amount of 5% by weight or less based on the total weight of the first resin layer.

According to another embodiment, the first resin layer may comprise a mixed resin obtained by mixing the polylactic acid-based polymer with a small amount of a vinyl acetate and vinyl laurate copolymer. In such an event, the vinyl acetate and vinyl laurate copolymer may be employed in an amount of 30% by weight or less based on the total weight of the first resin layer.

According to another embodiment, the first resin layer may comprise a mixed resin obtained by mixing the polylactic acid-based polymer with a butyl acrylate rubber having a core-shell structure. In such an event, the butyl acrylate rubber having a core-shell structure may be employed in an amount of 10% by weight or less based on the total weight of the first resin layer.

Meanwhile, according to an embodiment of the present invention, conventional electrostatic agents, antistatic agents, antioxidants, thermal stabilizers, ultraviolet ray blockers, anti-blocking agents, and other inorganic lubricants may be added to the first resin layer within a range that does not impair the effect of the present invention.

### Second Resin Layer

According to an embodiment, the second resin layer may comprise an aliphatic polyester-based resin or an aliphatic-aromatic copolymerized polyester-based resin as a main component.

Here, the aliphatic polyester-based resin may be a different resin from that used in the first resin layer. As the multilayer biodegradable film comprises a second resin layer comprising an aliphatic polyester-based resin or an aliphatic-aromatic copolymerized polyester-based resin as a main component along with the first resin layer, not only can flexibility be enhanced and noise level be reduced, but interlayer adhesion characteristics can be enhanced by virtue of good interlayer compatibility with the first resin layer comprising a polylactic acid-based polymer as a main component, and moldability, processability, and productivity can be further enhanced.

If the multilayer biodegradable film comprises only a first resin layer comprising a polylactic acid-based polymer as a main component, the polylactic acid-based polymer may have good mechanical and optical properties, whereas it lacks flexibility and has a high noise level; thus, when a multilayer biodegradable film is prepared, its use may be very limited. In addition, if the multilayer biodegradable film comprises only a first resin layer, and if the first resin layer is formed into a film by blending the polylactic acid-based polymer with an aliphatic polyester-based resin, different from the polylactic acid-based polymer, or an aliphatic-aromatic copolymerized polyester-based resin, the transparency of a final film is significantly reduced, which may limit its use in packaging applications that require transparency.

Specifically, the second resin layer may comprise an aliphatic polyester-based resin or an aliphatic-aromatic copolymerized polyester-based resin obtained by polycondensation of an acid component comprising an aliphatic or aromatic dicarboxylic acid as a main component and a glycol component comprising an alkylene glycol as a main component.

Specific examples of the aliphatic dicarboxylic acid include succinic acid, adipic acid, sebacic acid, glutaric acid, malonic acid, oxalic acid, azelaic acid, nonanedicarboxylic acid, and mixtures thereof.

Examples of the aromatic dicarboxylic acid include terephthalic acid, isophthalic acid, naphthalene-2,6-dicarboxylic acid, diphenylsulfonic acid dicarboxylic acid, diphenyl ether dicarboxylic acid, diphenoxyethanedicarboxylic acid, cyclohexanedicarboxylic acid, and mixtures thereof. It may be used with other aliphatic or aromatic dicarboxylic acid components.

Specific examples of the glycol component include alkylene glycols such as ethylene glycol, 1,3-propanediol, 1,4-butanediol, 1,5-pentanediol, 1,6-hexanediol, propylene glycol, neopentyl glycol, 2-methyl-1,3-propanediol, and diethylene glycol, 1,4-cyclohexanediol, 1,4-cyclohexanedimethanol, polyethylene glycol, and mixtures thereof.

Here, in order to achieve high biodegradability, the content of the aliphatic component among the acid components may be, for example, 30% by mole or more, for example, 40% by mole or more, for example, 45% by mole or more, or, for example, 50% by mole or more. Specifically, the content of the aliphatic component among the acid components may be 30% by mole to 80% by mole, 30% by mole to 70% by mole, or 40% by mole to 60% by mole. If the content of the aliphatic component among the acid components satisfies the above range, biodegradability can be further enhanced while the desired physical properties can be achieved.

According to an embodiment of the present invention, the aliphatic polyester-based resin or the aliphatic-aromatic copolymerized polyester-based resin may comprise, for example, at least one selected from the group consisting of a polybutylene adipate terephthalate (PBAT) resin, a polybutylene succinate (PBS) resin, a polybutylene adipate (PBA) resin, a polybutylene succinate-adipate (PBSA) resin, a polybutylene succinate-terephthalate (PBST) resin, a polyhydroxybutyrate-valerate (PHBV) resin, a polycaprolactone (PCL) resin, and a polybutylene succinate adipate terephthalate (PBSAT) resin. Specifically, the aliphatic polyester-based resin or the aliphatic-aromatic copolymerized polyester-based resin may comprise, for example, at least one selected from the group consisting of a polybutylene adipate terephthalate (PBAT) resin, a polybutylene succinate (PBS) resin, and a polybutylene adipate (PBA) resin.

More specifically, the aliphatic polyester-based resin may comprise, for example, at least one selected from the group consisting of a polybutylene succinate (PBS) resin and a polybutylene adipate (PBA) resin. For example, it may comprise a polybutylene succinate (PBS) resin. In addition, the aliphatic-aromatic copolymerized polyester-based resin may comprise, for example, at least one selected from the group consisting of a polybutylene adipate terephthalate (PBAT) resin and a polybutylene succinate-terephthalate (PBST) resin. For example, it may comprise a polybutylene adipate terephthalate (PBAT) resin.

A polybutylene adipate terephthalate (PBAT) resin is employed in the second resin layer according to an embodiment of the present invention; thus, it is environmentally friendly as it can be naturally decomposed by microorganisms, and it is possible to enhance mechanical properties such as fracture strength, tensile strength, elongation, optical properties, hardness, melt strength, and water resistance. In particular, it is possible to enhance tensile strength and elongation and lower Young's modulus, thereby enhancing flexibility while maintaining appropriate strength. In particular, the polybutylene adipate terephthalate (PBAT) resin has the advantages of better elasticity, flexibility, and a lower noise level than other biodegradable polyester resins such as polylactic acid-based polymers. For this reason, if a second resin layer comprising the polybutylene adipate terephthalate (PBAT) resin as a main component is formed and is then alternately laminated with the first resin layer comprising the polylactic acid polymer as a main component to form a multilayer biodegradable film, it has significant advantages in that it is possible to maintain appropriate strength, achieve excellent flexibility and transparency, and achieve a noise reduction effect at the same time, allowing it to be used in a variety of biodegradable products.

Meanwhile, according to an embodiment of the present invention, the second resin layer may comprise the aliphatic polyester-based resin or the aliphatic-aromatic copolymerized polyester-based resin alone.

According to another embodiment, the second resin layer may comprise mixed resin obtained by mixing the aliphatic polyester-based resin or the aliphatic-aromatic copolymerized polyester-based resin with a polyhydroxyalkanoate (PHA) unit. The polyhydroxyalkanoate (PHA) unit may comprise at least one selected from the group consisting of poly[3-hydroxybutyrate] (P3-HB); poly[4-hydroxybutyrate] (P4-HB); poly[3-hydroxyvalerate] (PHV); poly[3-hydroxybutyrate]-co-poly[3-hydroxyvalerate](PHBV); poly[3-hydroxyhexanoate] (PHC); poly[3-hydroxyheptanoate] (PHH); poly[3-hydroxyoctanoate] (PHO); poly[3-hydroxynonanoate] (PHN); poly[3-hydroxydecanoate](PHD); poly[3-hydroxydodecanoate] (PHDD); and poly[3-hydroxytetradecanoate](PHTD). Specifically, the polyhydroxyalkanoate (PHA) unit may be employed in an amount of 30% by weight or less based on the total weight of the second resin layer.

The aliphatic polyester-based resin or the aliphatic-aromatic copolymerized polyester-based resin may be employed in an amount of 50% by weight or more, specifically, 80% by weight or more, 85% by weight or more, 90% by weight or more, 95% by weight or more, 96% by weight or more, 97% by weight or more, or 98% by weight or more, based on the total weight of the second resin layer.

The aliphatic polyester-based resin or the aliphatic-aromatic copolymerized polyester-based resin may have a weight average molecular weight (Mw) of, for example, 50,000 to 400,000 g/mole, for example, 50,000 to 300,000 g/mole, for example, 50,000 to 200,000 g/mole, or, for example, 50,000 to 100,000 g/mole. The weight average molecular weight (Mw) may be measured by gel permeation chromatography (GPC). If the weight average molecular weight (Mw) of the aliphatic polyester-based resin or the aliphatic-aromatic copolymerized polyester-based resin satisfies the above range, compatibility and processability with the first resin layer comprising the polylactic acid polymer as a main component can be excellent, and flexibility, transparency, and a noise reduction effect can be further enhanced while appropriate strength of the multilayer biodegradable film is maintained.

Meanwhile, according to an embodiment of the present invention, conventional electrostatic agents, antistatic agents, antioxidants, thermal stabilizers, ultraviolet ray blockers, anti-blocking agents, and other inorganic lubricants may be added to the second resin layer within a range that does not impair the effect of the present invention.

### Third Resin Layer

Meanwhile, according to an embodiment of the present invention, a third resin layer, which comprises an aliphatic polyester-based resin or an aliphatic-aromatic copolymerized polyester-based resin different from that used in the second resin layer as a main component, may be alternately laminated with the first resin layer and the second resin layer within a range that does not impair the effect of the present invention.

Specific examples of the aliphatic polyester-based resin and the aliphatic-aromatic copolymerized polyester-based resin that can be used in the third resin layer are the same as those of the resins used in the second resin layer.

Likewise, conventional electrostatic agents, antistatic agents, antioxidants, thermal stabilizers, ultraviolet ray blockers, anti-blocking agents, and other inorganic lubricants may be added to the third resin layer within a range that does not impair the effect of the present invention.

### Corona Layer or Coating Layer

Meanwhile, in order to increase the effect of the subsequent processing within the scope that does not impair the effect of the present invention, at least one side of the surfaces of the film may be subjected to corona treatment to increase the processing suitability of the film, inorganic particle coating to prevent static electricity or blocking, or coating treatment to enhance printability with a print layer.

The multilayer biodegradable film according to an embodiment may further comprise a corona layer disposed on the other side of the first resin layer. Specifically, the corona layer may be directly formed on the other side of the first resin layer.

As the multilayer biodegradable film further comprises a corona layer, it is possible to remove contaminants such as oil from the surface of the multilayer biodegradable film and create a surface that is compatible with an adhesive area, thereby increasing adhesive strength, and to chemically and physically modify the surface, thereby further enhancing hydrophilicity, adhesion, printability, coating properties, deposition properties, and the like.

The corona layer is formed by corona treatment of the first resin layer and may comprise a polar functional group selected from the group consisting of —CO, —COOH, and —OH.

The surface tension for the corona-treated side in the first resin layer may be 38 dyn/cm or more, for example, 38 to 70 dyn/cm, for example, 38 to 68 dyn/cm, or, for example, 38 to 66 dyn/cm. If the surface tension for the corona-treated side of the first resin layer satisfies the above range, it is possible to further enhance adhesion, printability, coating properties, deposition properties, and the like.

The thickness of the corona layer may be appropriately adjusted depending on the use and purpose of the multilayer biodegradable film and may specifically be 0.1 nm to 1,000 nm, for example, 0.2 nm to 900 nm, or, for example, 0.1 nm to 800 nm, but it is not limited thereto.

The multilayer biodegradable film according to another embodiment may further comprise a coating layer disposed on the other side of the first resin layer.

The coating layer may comprise a primer coating layer. In such a case, antistatic performance can be enhanced.

The primer coating layer may be formed on the other side of the first resin layer. Alternatively, if the multilayer biodegradable film comprises the corona layer, the corona layer may be formed on the other side of the first resin layer, and the primer coating layer may be formed on the other side (lower side) of the corona layer.

Specifically, a primer coating layer may be formed by subjecting the other side of the first resin layer to primer treatment. Alternatively, a primer coating layer may be formed by subjecting one side (lower side) of the corona layer disposed on the other side of the first resin layer to primer treatment.

The primer coating layer may comprise at least one having antistatic performance selected from the group consisting of ammonium-based compounds, phosphoric acid-based compounds, and polymers such as acrylic resins and urethane-based resins.

The surface resistance of the primer coating layer may be 0.1 to 30Ω/□, 0.2 to 28Ω/□, 0.3 to 26Ω/□, 0.4 to 24Ω/□, or 1 to 20Ω/□.

The surface resistance may be evaluated for antistatic performance using a surface resistance meter at, for example, room temperature (22±2° C.) and relative humidity (60%±10%).

The thickness of the coating layer may be appropriately adjusted depending on the use and purpose of the multilayer biodegradable film and may specifically be 15 nm to 50 nm, 20 nm to 45 nm, 25 nm to 40 nm, or 30 nm to 35 nm, but it is not limited thereto.

### [Structural Characteristics of the Multilayer Biodegradable Film]

Referring back to FIG. 1, the multilayer biodegradable film (100) according to an embodiment of the present invention comprises two or more different thermoplastic resin layers alternately laminated, wherein the thermoplastic resin layers comprise a first resin layer (110) comprising a polylactic acid-based polymer as a main component and a second resin layer (120) comprising an aliphatic polyester-based resin or an aliphatic-aromatic copolymerized polyester-based resin as a main component.

In addition, the multilayer biodegradable film (100) may comprise a first resin layer (110′) as an outermost layer on both sides. Specifically, the outermost layers on both sides of the multilayer biodegradable film are first resin layers (110′).

When the outermost layers of the multilayer biodegradable film are first resin layers comprising a polylactic acid-based polymer as a main component, it may be more advantageous for stretching and more advantageous in terms of moldability, processability, and productivity. When the outermost layers of the multilayer biodegradable film comprise a second resin layer comprising an aliphatic polyester-based resin or an aliphatic-aromatic copolymerized polyester-based resin as a main component, stretching may not be readily carried out, casting may not be readily carried out, and adhesion may easily occur, thereby reducing moldability, processability, and productivity.

According to an embodiment of the present invention, the sum of the thicknesses of the outermost layers on both sides may be 5 to 40% of the total thickness of the film. Specifically, the sum of the thicknesses of the outermost layers on both sides may be 10 to 40%, 15 to 40%, 20 to 40%, 25 to 40%, 30 to 40%, 30 to 38%, or 30 to 37% of the total thickness of the film.

If the sum of the thicknesses of the outermost layers on both sides satisfies the above range, it may be more advantageous for achieving the effects desired in the present invention, more advantageous for stretching, and very advantageous in terms of moldability, processability, and productivity.

In addition, the resin layers in contact with the outermost layers on both sides may be a second resin layer.

According to an embodiment of the present invention, the total number of layers of the multilayer biodegradable film may be adjusted in light of the thickness of the individual layers of the film, but it may be 5 layers or more including the outermost layers on both sides. For example, the multilayer biodegradable film may have 5 to 500 layers, 5 to 300 layers, 5 to 250 layers, 5 to 225 layers, 7 to 400 layers, 7 to 350 layers, 7 to 300 layers, 7 to 250 layers, 7 to 220 layers, 10 to 200 layers, 10 to 150 layers, 10 to 100 layers, or 10 to 50 layers. If the multilayer biodegradable film has less than 5 layers including the outermost layers on both sides, there may be a problem of reduced transparency.

Meanwhile, in the multilayer biodegradable film according to an embodiment of the present invention, the average thickness ratio of individual layers of the first resin layers and the second resin layers, excluding the outermost layers on both sides, may be 1:0.5 to 2. The average thickness ratio of individual layers of the first resin layers and the second resin layers, excluding the outermost layers on both sides, may be, for example, 1:0.5 to 2, for example, 1:0.5 to 1.5, or, for example, 1:0.5 to 1.3. If the average thickness ratio of individual layers of the first resin layers and the second resin layers, excluding the outermost layers on both sides, satisfies the above range, it may be more advantageous in controlling the overall uniformity of the multilayer biodegradable film.

The average thickness of individual layers of the first resin layers, excluding the outermost layers on both sides, may be, for example, 10 to 1,000 nm, for example, 50 to 800 nm, or, for example, 100 to 600 nm.

The total thickness of the first resin layers, excluding the outermost layers on both sides, may be, for example, 3 μm to 40 μm, for example, 3 μm to 30 μm, for example, 3 μm to 20 μm, for example, 5 μm to 18 μm, or, for example, 5 μm to 15 μm.

The total thickness of the first resin layers, including the outermost layers on both sides, may be, for example, 5 μm to 60 μm, for example, 5 μm to 50 μm, for example, 8 μm to 40 μm, for example, 8 μm to 30 μm, for example, 10 μm to 30 μm, or, for example, 10 μm to 20 μm.

If the total thickness of the first resin layers and the average thickness of the individual layers thereof each satisfy the above ranges, it may be more advantageous for achieving the desired effects of the present invention.

The average thickness of individual layers of the second resin layers may be, for example, 10 to 800 nm, for example, 50 to 700 nm, or, for example, 100 to 600 nm. If the average thickness of individual layers of the second resin layers satisfies the above range, uniformity control may be easier. As a result, the appearance characteristics and mechanical properties of the film can be further enhanced.

The total thickness of the second resin layers may be, for example, 2.5 μm to 40 μm, for example, 4 μm to 30 μm, for example, 4 μm to 20 μm, for example, 4 μm to 15 μm, or, for example, 5 μm to 10 μm. If the total thickness of the second resin layers and the average thickness of the individual layers thereof each satisfy the above ranges, it may be more advantageous for achieving the desired effects of the present invention.

The total thickness of the multilayer biodegradable film, including the outermost layers on both sides, may be, for example, 7.5 μm to 100 μm, for example, 9 μm to 80 μm, for example, 12 μm to 55 μm, for example, 13 μm to 50 μm, for example, 13 μm to 40 μm, for example, 15 μm to 40 μm, for example, 15 μm to 35 μm, or, for example, 20 μm to 25 μm.

### [Physical Properties of the Multilayer Biodegradable Film]

The multilayer biodegradable film according to an embodiment is characterized by having excellent uniformity, flexibility, and transparency at the same time, along with a low noise level.

First, in the multilayer biodegradable film, the uniformity (LUI) of the first resin layers, represented by the following Equation 1, may be 0.2 μm or less.

$$L U I ( µm ) = \frac{\begin{matrix}( {t}_{ma x , N} - {t}_{m i n , N} ) + ( {t}_{ma x , C} - \\ {t}_{m i n , C} ) + ( {t}_{ma x , S} - {t}_{m i n , S} )\end{matrix}}{3} \qquad < Equation 1 >$$

In Equation 1, when the multilayer biodegradable film having a width of 500 mm and a thickness of 20 to 25 μm is cut in the thickness direction along a point (N) 50 mm away from one end in the transverse direction, a point (S) 50 mm away from the other end in the transverse direction, and a central point (C) in the transverse direction, and when the thicknesses of the individual layers, excluding the outermost layers on both sides, of the laminated first resin layers are measured using a field emission scanning electron microscope (FE-SEM) on the cross-section,

t_{max, N} is the maximum thickness of the thicknesses of the individual layers, excluding the outermost layers on both sides, of the first resin layers measured at point N of the multilayer biodegradable film,

t_{min, N} is the minimum thickness of the thicknesses of the individual layers, excluding the outermost layers on both sides, of the first resin layers measured at point N of the multilayer biodegradable film,

t_{max, S} is the maximum thickness of the thicknesses of the individual layers, excluding the outermost layers on both sides, of the first resin layers measured at point S of the multilayer biodegradable film,

t_{min, S} is the minimum thickness of the thicknesses of the individual layers, excluding the outermost layers on both sides, of the first resin layers measured at point S of the multilayer biodegradable film,

t_{max, C} is the maximum thickness of the thicknesses of the individual layers, excluding the outermost layers on both sides, of the first resin layers measured at point C of the multilayer biodegradable film, and

t_{min, C} is the minimum thickness of the thicknesses of the individual layers, excluding the outermost layers on both sides, of the first resin layers measured at point C of the multilayer biodegradable film.

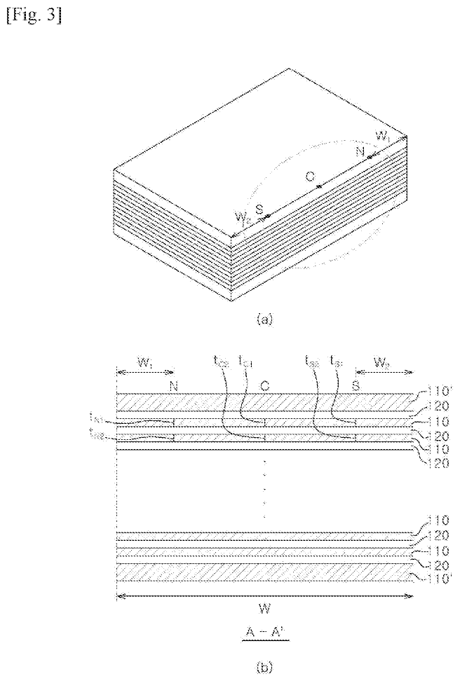

Here, the individual layers of the first resin layers refer to each layer excluding the outermost layers on both sides (110′ in FIGS. 1 and 3) among the first resin layers. Thus, the maximum and minimum thicknesses among the thicknesses of the individual layers (110) of the first resin layers each refer to the maximum and minimum thicknesses among the thicknesses of the individual layers (110), excluding the outermost layers on both sides (110′) among the first resin layers.

The uniformity (LUI) of the first resin layers, represented by the above Equation 1, may be an important physical property that determines the appearance characteristics, thickness uniformity, flexibility, transparency, and noise level of the multilayer biodegradable film. In particular, as the uniformity (LUI) of the first resin layers is adjusted to a specific range, the uniformity of the final multilayer biodegradable film can be controlled. As a result, the physical properties, appearance characteristics, and noise level of the film may vary.

In general, when a multilayer biodegradable film is molded, it is difficult to control the appearance and thickness of the film if there is a large thickness deviation by location from the viewpoint of uniformity. As a result, the flexibility and transparency of the film may decrease, and the noise level may increase, resulting in an overall deterioration in physical properties. Further, the thickness deviation by location makes stretching difficult and may cause a problem in terms of processability, productivity, and moldability.

Thus, since the uniformity (LUI) of the first resin layers can be an indicator of the quality of a molded product such as a packaging material comprising the multilayer biodegradable film, it is very important to reduce the thickness deviation by location of the first resin layers of the multilayer biodegradable film to control the uniformity (LUI).

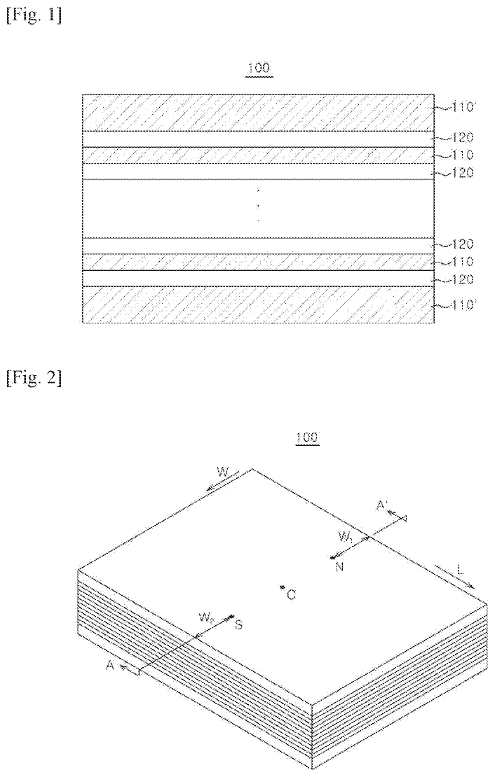

Referring to FIG. 2, when the multilayer biodegradable film (100) is cut (A-A′) in the thickness direction along a central point “C” in the transverse direction (W), a point “N” 50 mm away from one end in the transverse direction (W1), and a point “S” 50 mm away from the other end in the transverse direction (W2), the uniformity (LUI) of the multilayer biodegradable film may be measured using a field emission scanning electron microscope (FE-SEM) on the cross-section.

FIGS. 3(a) and 3(b) each show a perspective view (a) cut along line A-A′ in FIG. 2 and an enlarged cross-section view (b) thereof.

Referring to FIG. 3(b), the thickness at each location of the individual layers of the laminated first resin layers (excluding the thickness of the outermost layers (110′) on both sides), that is, the thickness at point N (t_{N1}, t_{N2}, t_{N3} . . . ), the thickness at point C (tc₁, t_{C2}, t_{C3} . . . ), and the thickness at point S (t_{S1}, tₛ₂, t_{S3} . . . ) is measured, respectively. The maximum thickness t_{max, N}, t_{max, C}, and t_{max, S} and the minimum thickness t_{min, N}, t_{min, C}, and t_{min, S} among the thicknesses of individual layers of the laminated first resin layers are measured, respectively. The uniformity (LUI) represented by Equation 1 may be calculated from these values. That is, the uniformity (LUI) of the first resin layers may be a value obtained by measuring the thickness at each location of individual layers, excluding the outermost layers on both sides, among the laminated first resin layers, subtracting the minimum value from the maximum value of the thickness at each location, and then dividing it by 3.

The uniformity (LUI) of the first resin layers may be lower as the thickness deviation by location of the first resin layers is lower, and it may be higher as the thickness deviation by location is higher.

In the multilayer biodegradable film, the uniformity (LUI) of the first resin layers may be, for example, 0.2 μm or less, for example, 0.15 μm or less, for example, 0.12 μm or less, for example, 0.1 μm or less, or, for example, 0.08 μm or less.

If the uniformity (LUI) of the first resin layers in the multilayer biodegradable film satisfies the above range, the deviation in uniformity by location of the multilayer biodegradable film can be reduced. As a result, the appearance characteristics of the film can be enhanced, flexibility and transparency can be further enhanced, and noise characteristics can be improved. In addition, if the uniformity (LUI) of the first resin layers satisfies the above range, thickness control and thickness deviation control are easier, whereby process controllability can be further enhanced. As a result, processability, productivity, and moldability can be further enhanced. If the uniformity (LUI) of the first resin layers exceeds the above range, there may be problems with the appearance characteristics of the film, and uniformity by location may deteriorate, causing marks or defects in each layer. As a result, physical properties may deteriorate at each location.

According to an embodiment of the present invention, when the multilayer biodegradable film has 5 to 30 layers and a thickness of 20 to 25 μm, the uniformity (LUI) of the first resin layers may be, for example, 0.1 μm or less, for example, 0.09 μm or less, or, for example, 0.08 μm or less.

According to another embodiment of the present invention, when the multilayer biodegradable film has greater than 30 to less than 50 layers and a thickness of 20 to 25 μm, the uniformity (LUI) of the first resin layers may be, for example, 0.15 μm or less, for example, 0.12 μm or less, or, for example, 0.10 μm or less.

According to another embodiment of the present invention, when the multilayer biodegradable film has 50 or more layers and a thickness of 20 to 25 μm, the uniformity (LUI) of the first resin layers may be, for example, 0.2 μm or less, for example, 0.15 μm or less, or, for example, 0.13 μm or less.

The smaller the uniformity (LUI) of the first resin layers within the above range is, the more advantageous it may be to achieve the object according to an embodiment of the present invention.

In addition, in the multilayer biodegradable film, the difference in uniformity (Δt_{N,S}) in the transverse direction of the multilayer biodegradable film, represented by the following Equation 2, may be 0.06 μm or less:

$$Δ {t}_{N , S} ( µm ) = \vert ( {t}_{ma x , N} - {t}_{m i n , N} ) - ( {t}_{ma x , S} - {t}_{m i n , S} ) \vert \qquad < Equation 2 >$$

in Equation 2, t_{max, N}, t_{min, N}, t_{max, S}, and t_{min, S} are as defined above.

Specifically, the difference in uniformity (Δt_{N,S}) between both ends in the transverse direction of the multilayer biodegradable film may be, for example, 0.05 μm or less, for example, 0.03 μm or less, for example, 0.027 μm or less, for example, 0.025 μm or less, for example, 0.02 μm or less, or, for example, 0.015 μm or less. The closer the difference in uniformity (Δt_{N,S}) between both ends in the transverse direction of the multilayer biodegradable film is to 0, the more advantageous. In such a case, the appearance characteristics of the film can be enhanced as thickness deviation between both ends of the film is reduced, flexibility and transparency can be further enhanced, and noise characteristics can be improved. If the difference in uniformity (Δt_{N,S}) between both ends in the transverse direction of the multilayer biodegradable film is outside the above range, there may be problems with the appearance characteristics of the film, and uniformity may deteriorate, thereby causing marks or defects in each layer. As a result, physical properties may deteriorate at each location.

According to an embodiment of the present invention, the difference between t_{max, N} and t_{min, N} for point N may be, for example, 0.15 μm or less, for example, 0.13 μm or less, for example, 0.12 μm or less, for example, 0.1 μm or less, for example, 0.08 μm or less, or, for example, 0.07 μm or less.

The difference between t_{max, S} and t_{min, S} for point S may be, for example, 0.15 μm or less, for example, 0.12 μm or less, for example, 0.1 μm or less, or, for example, less than 0.1 μm.

The difference between t_{max, C} and t_{min, C} for point C may be, for example, 0.2 μm or less, for example, 0.15 μm or less, for example, 0.13 μm or less, for example, 0.12 μm or less, or, for example, 0.1 μm or less.

If at least one of the difference between t_{max, N} and t_{min, N}, the difference between t_{max, S} and t_{min, S}, and the difference between t_{max, C} and t_{min, C} of the multilayer biodegradable film satisfies the above range, the appearance characteristics of the film can be enhanced as thickness deviation of the film is reduced, flexibility and transparency can be further enhanced, and noise characteristics can be improved.

Meanwhile, in the multilayer biodegradable film, the flexible noise complexity (FNC), represented by the following Equation 3, may be 20 or less:

$$F N C = \frac{Y M \times {N}_{A V G}}{1000} \qquad < Equation 3 >$$

In Equation 3, YM and N_{AVG} are values, excluding units, measured with a specimen of the multilayer biodegradable film, respectively.

When a specimen of the multilayer biodegradable film is prepared, cut to a size of 150 mm in length and 15 mm in width, mounted with a spacing between chucks of 50 mm, and tested at a tensile speed of 200 mm/minute according to ASTM D882, YM is Young's modulus (kgf/mm²) as a slope of the straight line between the starting point of measurement and an elongation of 3%.

When the multilayer biodegradable film is cut to a size of A4, 210 mm×297 mm and placed 30 cm away from a digital noise analyzer in a box of 650 (W) mm×450 (D) mm×500 (H) mm made of a polycarbonate, and both ends of the film are held with jigs and repeatedly twisted back and forth at a speed of 30 times/minute to make noise for more than 5 seconds, N_{AVG} is an average noise level (dB) of 5 measurements thereof.

The flexible noise complexity (FNC), represented by the above Equation 3, stands for the product of the Young's modulus and noise level of the multilayer biodegradable film divided by 1,000, which is an indicator of the degree of composite characteristics of flexibility and noise level of the multilayer biodegradable film.

The lower the Young's modulus and/or noise level of the multilayer biodegradable film, the lower the flexible noise complexity (FNC).

When the flexible noise complexity (FNC) with these characteristics satisfies the above specific range or less, the flexibility and transparency of the multilayer biodegradable film can be further enhanced, the noise level can be reduced, and, further, the quality of molded articles, such as packaging materials, comprising the multilayer biodegradable film can be further enhanced.

The flexible noise complexity (FNC) of the multilayer biodegradable film may be, for example, 20 or less, for example, 2 to 20, for example, 3 to 18, for example, 5 to 18, or, for example, 10 to 19. When the flexible noise complexity (FNC) satisfies the above range, the flexibility and noise characteristics of the multilayer biodegradable film can be improved at the same time.

Meanwhile, in Equation 3, the Young's modulus of the multilayer biodegradable film is preferably 300 kgf/mm² or less, 250 kgf/mm² or less, or 240 kgf/mm² or less. When a specimen of the multilayer biodegradable film is prepared, cut to a size of 150 mm in length and 15 mm in width, mounted with a spacing between chucks of 50 mm, and tested at a tensile speed of 200 mm/minute according to ASTM D882 using a tensile tester (Instron 5566A), Young's modulus (kgf/mm²) may be measured as a slope of the straight line between the starting point of measurement and an elongation of 3%.

The Young's modulus of a single-layer polylactic acid polymer film made by a common method is 350 kgf/mm² or more, which significantly reduces flexibility and makes the film rigid, which may limit its use. When the Young's modulus of the multilayer biodegradable film satisfies 300 kgf/mm² or less, it is more advantageous for controlling the flexible noise complexity (FNC) to 20 or less, making it possible to easily produce the desired effects.

In addition, in Equation 3, when the multilayer biodegradable film is cut to a size of A4, 210 mm×297 mm and placed 30 cm away from a digital noise analyzer (Cirrus Research PlC, model name: CR-162C) in a box of 650 (W) mm×450 (D) mm×500 (H) mm made of a polycarbonate, and both ends of the film are held with jigs and repeatedly twisted back and forth at a speed of 30 times/minute to make noise for more than 5 seconds, the average noise level (N_{AVG}) is defined as an average noise level of 5 measurements thereof.

In order to provide a high-quality packaging material, it is preferable to control the average noise level (N_{AVG}) of the multilayer biodegradable film to a certain range or lower.

Specifically, the average noise level (N_{AVG}) of the multilayer biodegradable film may be, for example, 86 dB or less, for example, 85 dB or less, for example, 80 dB or less, or, for example, 79.5 dB or less.

In particular, when the average noise level (N_{AVG}) of the multilayer biodegradable film is 80 dB or less, it is more advantageous for controlling the flexible noise complexity (FNC) to 20 or less, making it possible to provide a packaging material with good quality by virtue of a low noise level.

In addition, in the multilayer biodegradable film, the apparent noise quality composite index (QCI) of the film, represented by the following Equation 4, may be 28 or less:

$$Q C I = \frac{H Z + L U I + {N}_{A V G}}{3} \qquad < Equation 4 >$$

In Equation 4, HZ, LUI, and N_{AVG} are values, excluding units, measured with a specimen of the multilayer biodegradable film, respectively.

HZ is the haze (%) of the multilayer biodegradable film, and LUI and N_{AVG} are as defined above.

The apparent noise quality composite index (QCI), represented by the above Equation 4, stands for the sum of haze, uniformity, and noise level of the multilayer biodegradable film divided by 3, which is an indicator of the uniformity (LUI) of the first resin layers, and the degree of composite characteristics of the uniformity, transparency, and noise level of a final multilayer biodegradable film.

The apparent noise quality composite index (QCI) can satisfy the above range as the haze, uniformity, and noise characteristics (noise reduction effect) of the multilayer biodegradable film are all excellent. That is, the lower the haze, uniformity, and/or noise level of the multilayer biodegradable film, the lower the apparent noise quality composite index (QCI).

When the apparent noise quality composite index (QCI) with these characteristics satisfies the above specific range, the haze and uniformity of the multilayer biodegradable film can be further enhanced at the same time, the noise level can be reduced, and, further, the quality of molded articles, such as packaging materials, comprising the multilayer biodegradable film can be further enhanced.

The apparent noise quality composite index (QCI) of the multilayer biodegradable film may be, for example, 15 to 28, for example, 20 to 28, for example, 22 to 28, or, for example, 25 to 28. When the apparent noise quality composite index (QCI) satisfies the above specific range, flexibility, noise reduction effect, and transparency can be enhanced at the same time; thus, it can be used in a variety of fields as a packaging material, making it more advantageous for providing a high-quality, environmentally friendly packaging material.

In addition, the multilayer biodegradable film according to an embodiment of the present invention may preferably have a haze of 10% or less, 5% or less, or 3% or less. If the haze exceeds 10%, its use may be limited due to a lack of transparency.

The multilayer biodegradable film of the present invention may have a biodegradability of 60% or more, preferably 80% or more, more preferably 90% or more, due to the nature of the product intended to reduce environmental load.

### [Process for Preparing a Multilayer Biodegradable Film]

According to an embodiment, there is provided a process for preparing a multilayer biodegradable film, which comprises preparing a first resin comprising a polylactic acid-based polymer as a main component and a second resin comprising an aliphatic polyester-based resin or an aliphatic-aromatic copolymerized polyester-based resin as a main component, respectively (step 1); melt-extruding the first resin and the second resin, respectively, and alternately laminating a first resin layer and a second resin layer to obtain a sheet in which two or more different types of thermoplastic resin layers are alternately laminated (step 2); and biaxially stretching and heat setting the laminated sheet to obtain a multilayer biodegradable film (step 3), wherein the uniformity (LUI) of the first resin layers in the multilayer biodegradable film is 0.2 μm or less as represented by the above Equation 1.

In the process for preparing a multilayer biodegradable film according to an embodiment of the present invention, a first resin and a second resin each comprising a specific resin as a main component are melt-extruded to alternately laminate a first resin layer and a second resin layer to obtain a sheet in which two or more different thermoplastic resin layers are alternately laminated, which is then biaxially stretched and heat set; thus, it is possible to further enhance moldability, processability, and productivity and to obtain a multilayer biodegradable film with an improved noise level while having excellent uniformity, flexibility, and transparency at the same time as desired in the present invention in an economical and efficient manner.

In particular, in the process for preparing a multilayer biodegradable film, as the melting temperature of the first resin, that of the second resin, and the difference between the melting temperatures are controlled, the melt viscosity range of the first resin layer and that of the second resin layer can be efficiently controlled. The technical significance lies in that, as a result, the thickness of each layer is finely controlled at each location, and the uniformity (LUI) of the first resin layers can be adjusted to an optimal range.

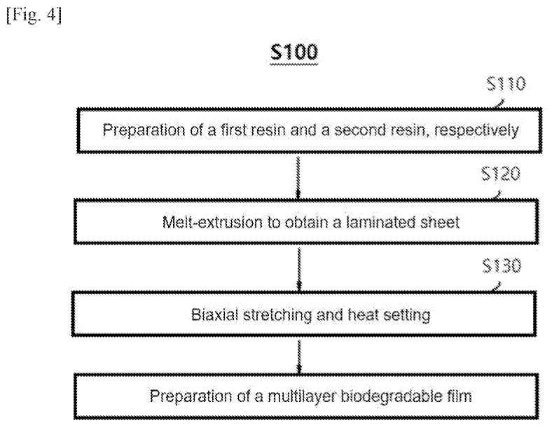

Referring to FIG. 4, the process for preparing a multilayer biodegradable film (S100) may comprise preparing a first resin comprising a polylactic acid-based polymer as a main component and a second resin comprising an aliphatic polyester-based resin or an aliphatic-aromatic copolymerized polyester-based resin as a main component, respectively (S110).

According to an embodiment of the present invention, since the first resin and the second resin each have a specific range of melt viscosity, and the melt viscosity range and melt viscosity difference between the first resin layer and the second resin layer formed therefrom are efficiently controlled to reduce the thickness deviation by location of the film, whereby uniformity can be controlled. As a result, the desired range of flexibility, transparency, and noise level can be achieved.

Thus, the melt viscosity of the first resin and that of the second resin can be very important factors in controlling the uniformity (LUI) of the first resin layers of the multilayer biodegradable film of the present invention.

In general, when a multilayer film of 5 layers or more, for example, 5 to several hundred layers, is formed, the thickness uniformity of the film may vary depending on the melt viscosity. In particular, the thickness uniformity and physical properties of the film may vary depending on the difference in melt viscosity. In particular, in a multilayer biodegradable film composed of thin layers, the larger the number of layers, the more difficult it is to control uniformity, and there may be a problem of increased deviation in the thickness of the layers by location.

Thus, as the melt viscosity of the first resin and that of the second resin, each forming the first resin layer and the second resin layer, are controlled according to an embodiment of the present invention, the difference in melt viscosity between the first resin layer and the second resin layer is reduced. As a result, the uniformity of the first resin layers can be controlled within the desired range.

Specifically, the first resin may have a melt viscosity at 210° C. of, for example, 5,000 poise to 12,000 poise, for example, 6,500 poise to 11,000 poise, or, for example, 8,000 poise to 10,000 poise. Here, the melt viscosity may be measured using a rheometer (RDS).

The melt viscosity of the first resin may be the same as, or similar to, the melt viscosity of the first resin layer formed therefrom. Thus, when the melt viscosity of the first resin satisfies the above range, a first resin layer having a melt viscosity in the same or similar range can be achieved. As a result, the uniformity of the first resin layers can be readily controlled to 0.2 μm or less. If the melt viscosity of the first resin is outside the above range, the thickness deviation by location of the multilayer biodegradable film may increase, and uniformity may deteriorate.

Meanwhile, the first resin may have a melting temperature (Tm) of, for example, 100° C. to 250° C., for example, 110° C. to 220° C., or, for example, 130° C. to 220° C.

The first resin may have a glass transition temperature (Tg) of, for example, 30° C. to 80° C., for example, 40° C. to 80° C., for example, 40° C. to 70° C., or, for example, 45° C. to 65° C.

When the melting temperature (Tm) and glass transition temperature (Tg) of the first resin each satisfy the above ranges, it may be more advantageous for enhancing the uniformity of the first resin layers of the multilayer biodegradable film, as well as the mechanical and optical properties.

Meanwhile, the second resin may have a melt viscosity at 210° C. of, for example, 4,000 poise to 8,000 poise, for example, 5,000 poise to 7,000 poise, or, for example, 6,000 poise to 7,000 poise.

The melt viscosity of the second resin may be the same as the melt viscosity of the second resin layer formed therefrom. When the melt viscosity of the second resin satisfies the above range, a second resin layer having a melt viscosity of the same range can be achieved, and the difference in melt viscosity of the first resin layer and the second resin layer can be controlled within the specific range as desired. Thus, it may be more advantageous for controlling the uniformity (LUI) of the first resin layers of the multilayer biodegradable film.

The first resin may be the same as the resin contained in the first resin layer described above in terms of type and characteristics.

In addition, the second resin may be the same as the resin contained in the second resin layer described above in terms of type and characteristics.

The process for preparing a multilayer biodegradable film (S100) may comprise melt-extruding the first resin and the second resin, respectively, and alternately laminating a first resin layer and a second resin layer to obtain a sheet in which two or more different types of thermoplastic resin layers are alternately laminated (S120).

According to an embodiment of the present invention, the melt extrusion temperatures of the first resin and the second resin are controlled to obtain a first resin layer and a second resin layer, which are alternately laminated to obtain a sheet in which two or more different types of thermoplastic resin layers are alternately laminated, whereby the thickness deviation by location of the final film is reduced to control uniformity. As a result, the desired range of flexibility, transparency, and noise level can be achieved.

Specifically, the first resin and the second resin obtained in step (S110) may be melt-extruded, respectively, using two extruders and a multilayer feed block in which two layers are alternately laminated. In addition, the first resin layer and the second resin layer are divided within the multilayer feed block, the divided first resin layer and the second resin layer are alternately laminated and passed through a die, and they are brought into contact with a cooling roll cooled to about 10° C. to 40° C. to obtain an unstretched multilayer biodegradable sheet.

In such an event, in order to obtain a multilayer biodegradable film with controlled uniformity within the specific range desired in the present invention, the melt extrusion temperatures of the first resin and the second resin and the difference between their melt extrusion temperatures may be very important. Specifically, the melt viscosity of the first resin and that of the second resin and the difference between their melt viscosities are important in order to obtain a multilayer biodegradable film with controlled uniformity within the specific range. This can be achieved by controlling the melt extrusion temperatures of the first resin and the second resin.

The extrusion temperature of the first resin and the extrusion temperature of the second resin may be the same or different. The difference between the melt extrusion temperature of the first resin and the melt extrusion temperature of the second resin may be, for example, 30° C. or less, for example, less than 30° C., for example, 20° C. or less, for example, 15° C. or less, for example, less than 15° C., for example, 10° C. or less, or, for example, 5° C. or less. In such a case, as the optimal viscosity difference section is secured, which reduces the thickness deviation by location of a final film, whereby the uniformity of the first resin layers can be controlled within the above range. As a result, the desired range of flexibility, transparency, and noise level can be achieved, and appearance characteristics can be improved.

The melt extrusion temperature of the first resin may be, for example, higher than 180° C. to 250° C., for example, 190° C. to 240° C., or, for example, 190° C. to 230° C.

The melt extrusion temperature of the second resin may be, for example, higher than 180° C. to 250° C., for example, 190° C. to 240° C., or, for example, 190° C. to 230° C.

The melt viscosity of the first resin layer and that of the second resin layer to be formed and the melt viscosity deviation can be controlled by the melt extrusion temperatures of the first resin and the second resin. If the melt extrusion temperatures of the first resin and the second resin are outside the above range, the desired melt viscosities of the first resin layer and the second resin layer may not be achieved. As a result, the thickness deviation by location of the multilayer biodegradable film increases, which makes it difficult to achieve the uniformity of the first resin layers in the desired range.

According to an embodiment of the present invention, the melt viscosity of the first resin layer may be greater than the melt viscosity of the second resin layer. In such a case, it is advantageous since the uniformity of the first resin layers by location of the multilayer biodegradable film can be easily controlled. If the melt viscosity of the second resin layer is greater than the melt viscosity of the first resin layer, there may be difficulty in achieving the desired effects of the present invention, and processability, productivity, and moldability may also be deteriorated.

In addition, it may be advantageous for achieving the effects desired in the present invention when the melt viscosity of the first resin layer is greater than the melt viscosity of the second resin layer, while the difference in melt viscosity is at a certain level or more.

In general, in a multilayer biodegradable film, or a coextruded article, composed of less than 5 layers, it is advantageous in terms of layer uniformity when the melt viscosities are similar to each other. However, in a multilayer biodegradable film of 5 layers or more, for example, tens of layers or more, especially a structure in which a first resin layer forms the outermost layers on both sides of the film, when the melt viscosity of the second resin layer is smaller than the melt viscosity of the first resin layer while their optimal melt viscosity difference (ΔV) is about 500 poise or more, for example, about 2,000 poise or more, the physical properties desired in the present invention can be achieved.

If the melt viscosity of the second resin layer is greater than, or similar to, the melt viscosity of the first resin layer, when the first resin layer and the second resin layer pass through a very narrow slit in the multilayer block and are alternately laminated, the pressure between the interfaces constituting the layers may increase, causing the layer configuration to become uneven. As the melt extrusion temperatures are controlled such that the melt viscosity of the second resin layer is smaller than the melt viscosity of the first resin layer with a difference therebetween within a specific range, optimal uniformity of the multilayer biodegradable film can be secured.

Specifically, the interlayer melt viscosity difference (ΔV) at 210° C., represented by the following Equation 5, may be 500 poise or more:

$$Δ V = V 1 - V 2 \qquad < Equation 5 >$$

In Equation 5, V1 is the melt viscosity of the first resin layer, and V2 is the melt viscosity of the second resin layer.

The interlayer melt viscosity difference (ΔV) at 210° C. may be, for example, 700 poise or more, for example, 800 poise or more, for example, 1,000 poise or more, for example, 1,500 poise or more, for example, 2,000 poise or more, for example, 2,200 poise or more, or, for example, 2,500 poise or more, and, for example, 3,500 poise or less, for example, 3,200 poise or less, for example, 3,000 poise or less, or, for example, 2,700 poise or less. Specifically, the interlayer melt viscosity difference (ΔV) at 210° C. may be 500 to 3,000 poise, or, for example, 700 to 3,000 poise.

Specifically, the first resin layer may have a melt viscosity at 210° C. of, for example, 7,000 poise to 12,000 poise, for example, 7,500 poise to 11,000 poise, or, for example, 8,000 poise to 10,000 poise. Here, the melt viscosity of the first resin layer may be measured using a rheometer (RDS).

The second resin layer may have a melt viscosity at 210° C. of, for example, 4,000 poise to 8,000 poise, for example, 5,000 poise to 7,000 poise, or, for example, 6,000 poise to 7,000 poise.

When the melt viscosity of the first resin layer and that of the second resin layer each satisfy the above ranges, the uniformity of the first resin layers of the multilayer film can be controlled, and it may be more advantageous for achieving the desired effects of the present invention.

In addition, during the melt extrusion, a sufficient constant amount can be transferred and plasticized by applying, for example, a constant amount of transfer equipment (e.g., a gear pump) within the melt transfer conduit. In such a case, when two extruders and a multilayer feed block in which two layers are alternately laminated are used, layer formation can be achieved well.

Meanwhile, according to an embodiment, a step of drying the first resin and the second resin before the melt extrusion may be further carried out. The drying step may be carried out, for example, at 60 to 100° C. for 4 hours to 24 hours.

Meanwhile, the process for preparing a multilayer biodegradable film (S100) may comprise biaxially stretching and heat setting the laminated sheet to obtain a multilayer biodegradable film (S130).

Specifically, the laminated sheet may be biaxially stretched. The biaxial stretching step may comprise, for example, preheating to 50° C. to 80° C., followed by longitudinal stretching of 2 to 4 times in the longitudinal direction (MD) at 40° C. to 100° C. and transverse stretching of 3 to 6 times in the transverse direction (TD) at 50° C. to 150° C.

As the laminated sheet is biaxially stretched in both directions, the physical properties and moldability of the multilayer biodegradable film can be further enhanced; thus, high-quality packaging materials can be achieved.

If uniaxial stretching is performed in only one of the longitudinal and transverse directions, the thickness deviation of the multilayer biodegradable film is severe, the strength of the direction in which stretching is not performed may decrease, and thermal properties may also deteriorate.

In addition, the heat setting step may be carried out at 50° C. to 150° C., 70° C. to 150° C., 100° C. to 150° C., or 110° C. to 140° C.

Meanwhile, in the process for preparing a multilayer biodegradable film (S100), a corona layer, a coating layer, or both may be further formed on the other side of the first resin layer.

Specifically, a corona layer may be formed by subjecting the first resin layer to corona treatment.

When high-frequency and high-voltage output is applied between a discharge electrode and a treatment roll, corona discharge takes place. Here, corona treatment can be carried out by passing the desired surface through it.

Specifically, the corona discharge intensity may be, for example, 3 to 20 kW. If the corona discharge intensity is less than the above range, the corona discharge treatment effect may be minimal. On the other hand, if the corona discharge intensity exceeds the above range, excessive surface modification may cause surface damage.

The configuration and physical properties of the corona layer are as described above.

In addition, a coating layer may be formed on the other side of the first resin layer.

The coating layer may comprise a primer coating layer. The primer coating layer may be formed by subjecting the other side of the first resin layer to primer treatment with a primer composition comprising at least one selected from the group consisting of ammonium-based compounds, phosphoric acid-based compounds, and polymers such as acrylic resins and urethane-based resins, which forms surface roughness to further enhance adhesion properties.

The primer coating layer may be formed on the other side of the first resin layer. Alternatively, if the multilayer biodegradable film comprises the corona layer, the corona layer may be formed on the other side of the first resin layer, and the primer coating layer may be formed on the other side of the corona layer.

In addition, the primer composition may contain a curing agent component. More specific examples thereof include 4,4′-diaminodiphenylmethane (DDM), aromatic diamines, and mixtures thereof. The amount of the curing agent component added may be 0.1 to 50% by weight based on the total weight of the primer composition.

The primer treatment method may be a conventional method used in the art, for example, spraying, brushing, rolling, and the like. Specifically, the primer composition may be sprayed using an airless spray onto the surface of the first resin layer under the conditions of an induction time of 1 to 30 minutes, a spray pressure of 5 to 500 MPa, a nozzle diameter of 0.46 to 0.58 mm, and a spray angle of 40 to 80°.

In addition, in order to increase the adhesion of the multilayer biodegradable film, surface treatment such as plasma treatment, ultraviolet irradiation treatment, frame treatment, or saponification treatment may be appropriately carried out.

When the multilayer biodegradable film is prepared according to the preparation process of the embodiment, it is economical and efficient, and it can be more effective in preparing a multilayer biodegradable film having the desired configuration and physical properties.

### [Multilayer Biodegradable Sheet and Process for Preparing the Same]

According to an embodiment, there may be provided a multilayer biodegradable sheet, which comprises two or more different thermoplastic resin layers alternately laminated, wherein the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUIₛ) of the first resin layers, represented by the following Equation 1-1, is less than 2.3 μm:

$$LUIs ( µm ) = \frac{\begin{matrix}( {t}_{ma x , N 1} - {t}_{m i n , N 1} ) + ( {t}_{ma x , C 1} - \\ {t}_{m i n , C 1} ) + ( {t}_{ma x , S 1} - {t}_{m i n , S 1} )\end{matrix}}{3} \qquad < Equation 1 >$$

In Equation 1-1, when the multilayer biodegradable sheet having a width of 650 mm and a thickness of 300 μm is cut in the thickness direction along a point (N) 50 mm away from one end in the transverse direction, a point (S) 50 mm away from the other end in the transverse direction, and a central point (C) in the transverse direction, and when the thicknesses of the individual layers of the laminated first resin layers are measured using a field emission scanning electron microscope (FE-SEM) on the cross-section,

t_{max, N1} is the maximum thickness of the thicknesses of the individual layers, excluding the outermost layers on both sides, of the first resin layers measured at point N of the multilayer biodegradable sheet,

t_{min, N1} is the minimum thickness of the thicknesses of the individual layers, excluding the outermost layers on both sides, of the first resin layers measured at point N of the multilayer biodegradable sheet,

t_{max, S1} is the maximum thickness of the thicknesses of the individual layers, excluding the outermost layers on both sides, of the first resin layers measured at point S of the multilayer biodegradable sheet,

t_{min, S1} is the minimum thickness of the thicknesses of the individual layers, excluding the outermost layers on both sides, of the first resin layers measured at point S of the multilayer biodegradable sheet,

t_{max, C1} is the maximum thickness of the thicknesses of the individual layers, excluding the outermost layers on both sides, of the first resin layers measured at point C of the multilayer biodegradable sheet, and

t_{min, C1} is the minimum thickness of the thicknesses of the individual layers, excluding the outermost layers on both sides, of the first resin layers measured at point C of the multilayer biodegradable sheet.

In the multilayer biodegradable sheet, the uniformity (LUIₛ) of the first resin layers may be, for example, 2.2 μm or less, for example, 2.0 μm or less, or, for example, less than 2.0 μm.

In the multilayer biodegradable sheet, when the uniformity (LUIₛ) of the first resin layers satisfies the above range, the deviation in uniformity by location of the multilayer biodegradable film can be reduced. As a result, the appearance characteristics of the sheet can be enhanced, transparency and flexibility can be further enhanced, and noise characteristics (noise reduction effect) can be improved.

The number of layers of the multilayer biodegradable sheet may be the same as the number of layers of the multilayer biodegradable film.

In addition, the total thickness of the multilayer biodegradable sheet may be, for example, 200 μm to 500 μm, for example, 250 μm to 450 μm, for example, 250 μm to 400 μm, or, for example, 250 μm to 350 μm.

Meanwhile, according to an embodiment of the present invention, there may be provided a process for preparing the multilayer biodegradable sheet.

Specifically, the process for preparing a multilayer biodegradable sheet comprises preparing a first resin comprising a polylactic acid-based polymer as a main component and a second resin comprising an aliphatic polyester-based resin or an aliphatic-aromatic copolymerized polyester-based resin as a main component, respectively (step 1); and melt-extruding the first resin and the second resin, respectively, and alternately laminating a first resin layer and a second resin layer to obtain a sheet in which two or more different types of thermoplastic resin layers are alternately laminated (step 2).

Steps 1 and 2 may be carried out in the same manner as steps 1 and 2 in the process for preparing a multilayer biodegradable film.

### [Environmentally Friendly Packaging Material]

According to an embodiment of the present invention, there may be provided an environmentally friendly packaging material, which comprises the multilayer biodegradable film.

Specifically, the environmentally friendly packaging material comprises a multilayer biodegradable film, wherein the multilayer biodegradable film comprises two or more different thermoplastic resin layers alternately laminated, the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUI) of the first resin layers is 0.2 μm or less as represented by the above Equation 1.

The environmentally friendly packaging material may be in the form of a film that can be used as general disposable films and food packaging materials, in the form of a fiber that can be used as fabrics, knitted fabrics, nonwoven fabrics, ropes, or in the form of a container that can be used as a container for food packaging such as a lunch box.

As the environmentally friendly packaging material comprises a multilayer biodegradable film with a low noise level while having excellent uniformity, flexibility, and transparency at the same time, it can provide excellent physical properties and quality. In addition, a packaging material, which is biodegradable and has environmentally friendly features as it completely decomposes when landfilled, can be provided; thus, it can be used in various fields as a packaging material to exhibit excellent characteristics.

### Mode for the Invention

Hereinafter, the present invention will be described in detail with reference to Examples. The following examples are merely illustrative of the present invention, and the scope of the present invention is not limited thereto.

### EXAMPLE

### Example 1: Preparation of a Multilayer Biodegradable Film

A polylactic acid resin (Nature Works LLC, 4032D) with a D-lactide content of about 1.4% and a melt viscosity of about 8,770 poise at about 210° C. was used as a resin for a first resin layer; and a polybutylene adipate-terephthalate (PBAT) resin (XINJIANG BLUE RIDGE TUNHE POLYESTER CO., LTD.), as an aliphatic-aromatic copolymerized polyester resin, having a melt viscosity of about 6,259 poise at 210° C. and an aliphatic content of 50% by mole among the acid components was used as a resin for a second resin layer.

The resin for a first resin layer was dried at about 80° C. for 6 hours using a dehumidifying dryer, and the resin for a second resin layer was dried at about 80° C. for 2 hours using a dehumidifying dryer, to remove moisture. Using two extruders and a multilayer feed block in which two layers are alternately laminated, the resin for a first resin layer was melt-extruded with an extruder at a temperature of 210° C., and the resin for a second resin layer was melt-extruded with an extruder at a temperature of 210° C.

Within the multilayer feed block, the first resin layer was divided into 15 layers, and the second resin layer was divided into 14 layers. The divided first resin layer and the second resin layer were passed through a die to be alternately laminated, and they were brought into contact with a cooling roll cooled to about 21° C. to obtain an unstretched multilayer biodegradable sheet having 29 layers. In such an event, the first resin layer was placed on the outermost layers on both the upper and lower sides, and the sum of the thicknesses of the outermost layers on both sides was 30% of the total thickness.

The unstretched multilayer biodegradable sheet thus obtained was stretched 3.0 times in the longitudinal direction at about 65° C. and 3.9 times in the transverse direction at 120° C., heat set at 150° C., and given a relaxation rate of 1% to prepare a biodegradable multilayer film having 29 layers, a total thickness of 20 μm, and a uniformity (LUI) of the first resin layers of about 0.077 μm.

### Example 2: Preparation of a Multilayer Biodegradable Film

A multilayer biodegradable film having 43 layers with a total thickness of 25 μm was prepared in the same manner as in Example 1, except that the thickness of the first resin layer and that of the second resin layer, the total number of layers of the film, the sum of the thicknesses of the outermost layers on both sides, and the uniformity (LUI) of the first resin layers were adjusted as shown in Table 1, respectively.

### Example 3: Preparation of a Multilayer Biodegradable Film

A multilayer biodegradable film having 57 layers with a total thickness of 20 μm was prepared in the same manner as in Example 1, except that the thickness of the first resin layer and that of the second resin layer, the total number of layers of the film, the sum of the thicknesses of the outermost layers on both sides, and the uniformity (LUI) of the first resin layers were adjusted as shown in Table 1, respectively.

### Comparative Example 1: Preparation of a Single-Layer Biodegradable Film

The same polylactic acid resin as in Example 1 was used as a resin for a first resin layer, and it was dried in a dehumidifying dryer at about 80° C. for 6 hours to remove moisture. The resin for a first resin layer from which moisture had been removed was melt-extruded using an extruder at a temperature of 210° C., passed through a 780-mm die, and then brought into contact with a cooling roll cooled to 20° C. to obtain a single-layer unstretched sheet. The single-layer unstretched sheet thus obtained was stretched 3.0 times in the longitudinal direction at 65° C. and 3.8 times in the transverse direction at 120° C., heat set at 120° C., and given a relaxation rate of 1% to prepare a single-layer biodegradable film having a thickness of 20 μm.

### Comparative Example 2: Preparation of a Single-Layer Biodegradable Film

The resin for a first resin layer and the resin for a second resin layer used in Example 1 were hand-mixed at a weight ratio of 80:20 and then blended in a 45 pi(Φ) twin-screw extruder at 200° C. It was dried in a dehumidifying dryer at about 60° C. for 8 hours to remove moisture and then melt-extruded at 200° C. to obtain a single-layer film having a thickness of 30 μm.

### Comparative Example 3: Preparation of a Multilayer Biodegradable Film

A multilayer biodegradable film having 29 layers with a total thickness of 20 μm was prepared in the same manner as in Example 1, except that the resin for a first resin layer was melt-extruded by an extruder at a temperature of 210° C., the resin for a second resin layer was melt-extruded by an extruder at a temperature of 180° C., the thickness of the first resin layer and that of the second resin layer, the sum of the thicknesses of the outermost layers on both sides, and the uniformity (LUI) of the first resin layers were adjusted as shown in Table 1, respectively.

### Comparative Example 4: Preparation of a Multilayer Biodegradable Film

A multilayer biodegradable film having 43 layers with a total thickness of 25 μm was prepared in the same manner as in Example 2, except that the resin for a first resin layer was melt-extruded by an extruder at a temperature of 210° C., the resin for a second resin layer was melt-extruded by an extruder at a temperature of 140° C., the thickness of the first resin layer and that of the second resin layer, the sum of the thicknesses of the outermost layers on both sides, and the uniformity (LUI) of the first resin layers were adjusted as shown in Table 1, respectively.

### Comparative Example 5: Preparation of a Multilayer Biodegradable Film

A multilayer biodegradable film having 57 layers with a total thickness of 20 μm was prepared in the same manner as in Example 3, except that the resin for a first resin layer was melt-extruded by an extruder at a temperature of 210° C., the resin for a second resin layer was melt-extruded by an extruder at a temperature of 190° C., the thickness of the first resin layer and that of the second resin layer, the sum of the thicknesses of the outermost layers on both sides, and the uniformity (LUI) of the first resin layers were adjusted as shown in Table 1, respectively.

The characteristics of each layer and process conditions for the single-layer or multilayer biodegradable films prepared according to Examples 1 to 3 and Comparative Examples 1 to 5 are summarized in Table 1 below.

TABLE 1

| | | Example | | | Comparative Example | | | | |
|---|---|---|---|---|---|---|---|---|---|
| | | 1 | 2 | 3 | 1 | 2 | 3 | 4 | 5 |
| Film structure | | PLA/PBAT | | | PLA | PLA + PBAT | PLA/PBAT | | |
| | | lamination | | | alone | blending | lamination | | |
| 1st | component | PLA | PLA | PLA | PLA | PLA 80% | PLA | PLA | PLA |
| resin | Total number of the | 15 | 22 | 29 | 1 | — | 15 | 22 | 29 |
| | first resin layers | | | | | | | | |
| | including the | | | | | | | | |
| | outermost layers on | | | | | | | | |
| | both sides | | | | | | | | |
| | Total thickness of the | 11.92 | 16.35 | 15.26 | 20 | — | 13.3 | 18.6 | 16.1 |
| | first resin layers | | | | | | | | |
| | including the | | | | | | | | |
| | outermost layers on | | | | | | | | |
| | both sides (μm) | | | | | | | | |
| | Outermost layers on | 30.2 | 36.2 | 40 | — | — | 31.8 | 37.8 | 42.7 |
| | both sides (%) relative | | | | | | | | |
| | to the thickness of the | | | | | | | | |
| | entire film | | | | | | | | |
| 2nd | Component | PBAT | PBAT | PBAT | — | PBAT 20% | PBAT | PBAT | PBAT |
| resin | Aliphatic content | 50 | 50 | 50 | — | — | 50 | 50 | 50 |
| | Total number of the | 14 | 21 | 28 | — | — | 14 | 21 | 28 |
| | second resin layers | | | | | | | | |
| | Total thickness of the | 8.08 | 8.65 | 4.74 | — | — | 6.7 | 6.4 | 3.9 |
| | second resin layers | | | | | | | | |
| | (μm) | | | | | | | | |
| Process | ME1 (° C.) | 210 | 210 | 210 | 210 | 210 | 210 | 210 | 210 |
| | ME2 (° C.) | 210 | 210 | 210 | — | 210 | 180 | 140 | 190 |
| | ΔME (° C.) | 0 | 0 | 0 | — | 0 | 30 | 70 | 20 |
| | V1 (poise) | 8,770 | 8,770 | 8,770 | 8,770 | — | 8,770 | 8,770 | 8,770 |
| | V2 (poise) | 6,259 | 6,259 | 6,259 | — | — | 8,971 | 13,797 | 8,271 |
| | ΔV (poise) | 2,511 | 2,511 | 2,511 | N/A | N/A | −201 | −5,027 | 499 |

ME1: extrusion temperature (° C.) of the first resin,
ME2: extrusion temperature (° C.) of the second resin
ΔME: difference in extrusion temperature (° C.) between the first resin and the second resin
V1: melt viscosity (poise) of the first resin layer,
V2: melt viscosity (poise) of the second resin layer
ΔV: difference in melt viscosity (poise) between the first resin layer and the second resin layer

### EVALUATION EXAMPLE

The single-layer and multilayer biodegradable films prepared according to Examples 1 to 3 and Comparative Examples 1 to 5 were each measured for physical properties and performance in the following manner. The results are shown in Table 2 below.

### Evaluation Example 1: Thickness

The thickness for the entire width of the single-layer or multilayer biodegradable films prepared in the Examples and Comparative Examples was measured.

The thickness of the multilayer biodegradable film was measured using MFC-101 (Nikon) by dividing the film width of 500 mm into 10-point intervals and calculating an average thereof.

### Evaluation Example 2: Uniformity (LUI)

### <Uniformity of the First Resin Layers of the Multilayer Biodegradable Film>

In the multilayer biodegradable films of Examples 1 to 3 and Comparative Examples 3 to 5, the uniformity (LUI) of the first resin layers was measured.

Specifically, referring to FIGS. 1 and 3, in each of the multilayer biodegradable films prepared according to Examples 1 to 3 and Comparative Examples 3 to 5, a central point in the transverse direction (W) was set to “C,” a point 50 mm away from one end in the transverse direction (W1) was set to “N,” and a point 50 mm away from the other end in the transverse direction (W2) was set to “S.” The multilayer biodegradable film was then cut (A-A′) in the thickness direction along them. The thickness of each location of the individual layers of the laminated first resin layers was measured on the cross-section using a field emission scanning electron microscope (FE-SEM) (JSM-6701F, JEOL).

Referring to FIG. 3(b), the thickness at each location of the individual layers of the laminated first resin layers, that is, the thickness at point N (t_{N1}, t_{N2}, t_{N3} . . . ), the thickness at point C (tc₁, t_{C2}, t_{C3} . . . ), and the thickness at point S (t_{S1}, t_{S2}, t_{S3} . . . ) were measured, respectively. The maximum thickness t_{max, N}, t_{max, C}, and t_{max, S} and the minimum thickness t_{min, N}, t_{min, C}, and t_{min, S} among the thicknesses at each location of individual layers of the laminated first resin layers were obtained, respectively. The uniformity (LUI) represented by Equation 1 was calculated from these values.

The maximum and minimum thicknesses among the thicknesses of the individual layers of the first resin layers were obtained from the thicknesses at each location of the individual layers of the laminated first resin layers. The uniformity (LUI) represented by the following Equation 1 was calculated from these values.

$$L U I ( µm ) = \frac{\begin{matrix}( {t}_{ma x , N} - {t}_{m i n , N} ) + ( {t}_{m ax , C} - \\ {t}_{m i n , C} ) + ( {t}_{m ax , S} - {t}_{m i n , S} )\end{matrix}}{3} \qquad < Equation 1 >$$

In Equation 1, when the multilayer biodegradable film having a width of 500 mm and a thickness of 20 to 25 μm is cut in the thickness direction along a point (N) 50 mm away from one end in the transverse direction, a point (S) 50 mm away from the other end in the transverse direction, and a central point (C) in the transverse direction, and when the thicknesses of the individual layers, excluding the outermost layers on both sides, of the laminated first resin layers are measured using a field emission scanning electron microscope (FE-SEM) on the cross-section,

t_{max, N} is the maximum thickness of the thicknesses of the individual layers, excluding the outermost layers on both sides, of the first resin layers measured at point N of the multilayer biodegradable film,

t_{min, N} is the minimum thickness of the thicknesses of the individual layers, excluding the outermost layers on both sides, of the first resin layers measured at point N of the multilayer biodegradable film,

t_{max, S} is the maximum thickness of the thicknesses of the individual layers, excluding the outermost layers on both sides, of the first resin layers measured at point S of the multilayer biodegradable film,

t_{min, S} is the minimum thickness of the thicknesses of the individual layers, excluding the outermost layers on both sides, of the first resin layers measured at point S of the multilayer biodegradable film,

t_{max, C} is the maximum thickness of the thicknesses of the individual layers, excluding the outermost layers on both sides, of the first resin layers measured at point C of the multilayer biodegradable film, and

t_{min, C} is the minimum thickness of the thicknesses of the individual layers, excluding the outermost layers on both sides, of the first resin layers measured at point C of the multilayer biodegradable film.

Here, the individual layers of the first resin layers refer to each layer excluding the outermost layers on both sides (110′ in FIGS. 1 and 3) among the first resin layers. Thus, the maximum and minimum thicknesses among the thicknesses of the individual layers (110) of the first resin layer each refer to the maximum and minimum thicknesses among the thicknesses of the individual layers (110), excluding the outermost layers on both sides (110′) among the first resin layers.

### <Uniformity of the Unstretched Sheet>

The maximum and minimum thicknesses among the thicknesses of the individual layers of the first resin layers at each location were measured for each of the multilayer biodegradable sheets (unstretched sheets) of Examples 1 to 3 and Comparative Examples 3 to 5 in the same manner as the uniformity (LUI) of the first resin layers of the multilayer biodegradable film. The uniformity (LUIₛ) represented by the following Equation 1-1 was calculated from these values.

$$L U Is ( µm ) = \frac{\begin{matrix}( {t}_{ma x , N 1} - {t}_{m i n , N 1} ) + ( {t}_{m ax , C 1} - \\ {t}_{m i n , C 1} ) + ( {t}_{m ax , S 1} - {t}_{m i n , S 1} )\end{matrix}}{3} \qquad < Equation 1 - 1 >$$

In Equation 1-1, when the multilayer biodegradable sheet having a width of 650 mm and a thickness of 300 μm is cut in the thickness direction along a point (N) 50 mm away from one end in the transverse direction, a point (S) 50 mm away from the other end in the transverse direction, and a central point (C) in the transverse direction, and when the thicknesses of the individual layers of the laminated first resin layers are measured using a field emission scanning electron microscope (FE-SEM) on the cross-section,

t_{max, N1} is the maximum thickness of the thicknesses of the individual layers, excluding the outermost layers on both sides, of the first resin layers measured at point N of the multilayer biodegradable sheet,

t_{min, N1} is the minimum thickness of the thicknesses of the individual layers, excluding the outermost layers on both sides, of the first resin layers measured at point N of the multilayer biodegradable sheet,

t_{max, S1} is the maximum thickness of the thicknesses of the individual layers, excluding the outermost layers on both sides, of the first resin layers measured at point S of the multilayer biodegradable sheet,

t_{min, S1} is the minimum thickness of the thicknesses of the individual layers, excluding the outermost layers on both sides, of the first resin layers measured at point S of the multilayer biodegradable sheet,

t_{max, C1} is the maximum thickness of the thicknesses of the individual layers, excluding the outermost layers on both sides, of the first resin layers measured at point C of the multilayer biodegradable sheet, and

t_{min, c1} is the minimum thickness of the thicknesses of the individual layers, excluding the outermost layers on both sides, of the first resin layers measured at point C of the multilayer biodegradable sheet.

Here, the individual layers of the first resin layers refer to each layer excluding the outermost layers on both sides (110′ in FIGS. 1 and 3) among the first resin layers. Thus, the maximum and minimum thicknesses among the thicknesses of the individual layers (110) of the first resin layer each refer to the maximum and minimum thicknesses among the thicknesses of the individual layers (110), excluding the outermost layers on both sides (110′) among the first resin layers.

### Evaluation Example 3: Haze (HZ)

It was measured according to the ASTM D1003 standard using a hazemeter (model name: SEP-H) from Nihon Semitsu Kogaku.

### Evaluation Example 4: Young's Modulus (YM)

According to ASTM D882, when a specimen of each of the single-layer and multilayer biodegradable films prepared in the Examples and Comparative Examples was prepared, cut to a size of 150 mm in length and 15 mm in width, mounted with a spacing between chucks of 50 mm, and tested at a tensile speed of 200 mm/minute using a tensile tester (Instron 5566A), Young's modulus (kgf/mm²) was measured as a slope of the straight line between the starting point of measurement and an elongation of 3%.

### Evaluation Example 5: Noise Level (N_{AVG})

When each of the single-layer and multilayer biodegradable films prepared in the Examples and Comparative Examples was cut to a size of A4, 210 mm×297 mm and placed 30 cm away from a digital noise analyzer (Cirrus Research PlC, model name: CR-162C) in a box of 650 (W) mm×450 (D) mm×500 (H) mm made of a polycarbonate, and both ends of the film were held with jigs and repeatedly twisted back and forth at a speed of 30 times/minute to make noise for more than 5 seconds, the average noise level (N_{AVG}) was measured as an average noise level of 5 measurements thereof.

### Evaluation Example 6: Flexible Noise Complexity (FNC)

The flexible noise complexity (FNC) represented by the following Equation 3 was calculated using the YM and N_{AVG} values measured in Evaluation Examples 4 and 5:

$$F N C = \frac{Y M \times {N}_{A V G}}{1000} \qquad < Equation 3 >$$

In Equation 3, YM and N_{AVG} are values, excluding units, measured with a specimen of the multilayer biodegradable film, respectively.

According to ASTM D882, when a specimen of the multilayer biodegradable film is prepared, cut to a size of 150 mm in length and 15 mm in width, mounted with a spacing between chucks of 50 mm, and tested at a tensile speed of 200 mm/minute, YM is Young's modulus (kgf/mm²) as a slope of the straight line between the starting point of measurement and an elongation of 3%.

When the multilayer biodegradable film is cut to a size of A4, 210 mm×297 mm and placed 30 cm away from a digital noise analyzer in a box of 650 (W) mm×450 (D) mm×500 (H) mm made of a polycarbonate, and both ends of the film are held with jigs and repeatedly twisted back and forth at a speed of 30 times/minute to make noise for more than 5 seconds, N_{AVG} is an average noise level (dB) of 5 measurements thereof.

### Evaluation Example 7: Apparent Noise Quality Composite Index (QCI)

The apparent noise quality composite index (QCI) represented by the following Equation 4 was calculated using the LUI, HZ, and N_{AVG} values measured in Evaluation Examples 2, 3, and 5:

$$Q C I = \frac{H Z + LUI + {N}_{A V G}}{3} \qquad < Equation 4 >$$

In Equation 4, HZ, LUI, and N_{AVG} are values, excluding units, measured with a specimen of the multilayer biodegradable film, respectively.

HZ is the haze (%) of the multilayer biodegradable film, and LUI is the uniformity represented by the above Equation 1.

When the multilayer biodegradable film is cut to a size of A4, 210 mm×297 mm and placed 30 cm away from a digital noise analyzer in a box of 650 (W) mm×450 (D) mm×500 (H) mm made of a polycarbonate, and both ends of the film are held with jigs and repeatedly twisted back and forth at a speed of 30 times/minute to make noise for more than 5 seconds, N_{AVG} is an average noise level (dB) of 5 measurements thereof.

TABLE 2

| | | | Outermost | | | | | | | | |
|---|---|---|---|---|---|---|---|---|---|---|---|
| | | | layers on | Example | | | Comparative Example | | | | |
| | | | both sides | 1 | 2 | 3 | 1 | 2 | 3 | 4 | 5 |
| Sheet | Total number of | | ○ | 29 | 43 | 57 | — | — | 29 | 43 | 57 |
| properties | sheets (layers) | | | | | | | | | | |
| | Sheet thickness | | ○ | 299.2 | 297.2 | 310.39 | — | — | 298.5 | 274.6 | 305.6 |
| | (μm) | | | | | | | | | | |
| | LUIs | | x | 1.16 | 1.12 | 1.91 | — | — | 3.71 | 4.73 | 2.3 |
| Film | Total number of | | ○ | 29 | 43 | 57 | 1 | 1 | 29 | 43 | 57 |
| properties | films (layers) | | | | | | | | | | |
| | Film thickness | | ○ | 20 | 25 | 20 | 20 | 30 | 20 | 25 | 20 |
| | (μm) | | | | | | | | | | |
| | Haze (HZ) (%) | | ○ | 2.6 | 2.4 | 2.9 | 3.1 | 25 | 3.5 | 2.5 | 3.5 |
| | Young's | | ○ | 221 | 228 | 233 | 384 | 173 | 268 | 229 | 268 |
| | modulus (YM) | | | | | | | | | | |
| | (kgf/mm2) | | | | | | | | | | |
| | Noise level | | ○ | 77.8 | 78.2 | 79.5 | 88.3 | 78 | 82 | 81.6 | 82 |
| | (N_{AVG}) (dB) | | | | | | | | | | |
| | First | Point S | x | 0.070 | 0.073 | 0.117 | — | — | 0.219 | 0.472 | 0.284 |
| | resin | Point C | x | 0.097 | 0.110 | 0.123 | — | — | 0.242 | 0.265 | 0.195 |
| | layer | Point N | x | 0.064 | 0.100 | 0.128 | — | — | 0.284 | 0.553 | 0.184 |
| | tₘₐₓ - | | | | | | | | | | |
| | tₘᵢₙ | | | | | | | | | | |
| | (μm) | | | | | | | | | | |

| | | | | | | | | | |
|---|---|---|---|---|---|---|---|---|---|
| LUI (μm) | x | 0.077 | 0.094 | 0.122 | n/a | — | 0.248 | 0.430 | 0.221 |
| Δt_{N, S} (μm) | x | 0.006 | 0.027 | 0.011 | — | — | 0.065 | 0.081 | 0.100 |
| FNC | ○ | 17.19 | 17.83 | 18.52 | 33.91 | 13.49 | 21.98 | 18.69 | 21.98 |
| QCI | ○ | 26.83 | 26.90 | 27.51 | — | — | 28.58 | 28.18 | 28.57 |

$\text{<Equation 1>} L U I = \frac{( {t}_{ma x , N} - {t}_{m i n , N} ) + ( {t}_{ma x , C} - {t}_{m i n , C} ) + ( {t}_{m ax , S} - {t}_{m i n , S} )}{3}$ $\text{<Equation 1-1>} L U Is ( µm ) = \frac{\begin{matrix}( {t}_{m ax , N 1} - {t}_{m i n , N 1} ) + ( {t}_{m ax , C 1} - \\ {t}_{m i n , C 1} ) + ( {t}_{m ax , S 1} - {t}_{m i n , S 1} )\end{matrix}}{3}$ <Equation 2> Δ t_{N,S} = |(t_{max, N} − t_{min, N}) − (t_{max, S} − t_{min, S})|
$\text{<Equation 3>} F N C = \frac{Y M \times {N}_{A V G}}{1000}$ $\text{<Equation 4>} Q C I = \frac{H Z + L U I + {N}_{AVG}}{3}$

As shown in Table 2, the multilayer biodegradable sheets and films of Examples 1 to 3 according to the present invention had very excellent uniformity of the first resin layers and were overall excellent in physical properties such as flexibility, noise level, and transparency as compared with the single-layer or multilayer biodegradable sheets and films of the Comparative Examples.

Specifically, as to the uniformity of the first resin layers, in Examples 1 to 3, the uniformity (LUIₛ) of the first resin layers of the multilayer biodegradable sheets was 1.12 to 1.91, and the uniformity (LUI) of the first resin layers of the multilayer biodegradable films was 0.077 to 0.122. The uniformity of the first resin layers was significantly improved as compared with the multilayer biodegradable sheets and films of Comparative Examples 3 to 5 with an LUIₛ and an LUI of 2.3 or more and 0.221 or more, respectively.

In addition, as to flexibility and noise level, the multilayer biodegradable films of Examples 1 to 3 had a Young's modulus of 221 kgf/mm² to 233 kgf/mm² and a noise level of 79.5 dB or less, whereas the single-layer biodegradable film of Comparative Example 1 had a Young's modulus of 384 kgf/mm² and a noise level of 88.3 dB, indicating that the flexibility was reduced, and the noise level was very high. In addition, when the multilayer biodegradable films of Comparative Examples 3 to 5 are compared with the multilayer biodegradable films of Examples 1 to 3 having the same number and thickness of layers, they had reduced flexibility and very high noise levels.

Meanwhile, as to transparency, the multilayer biodegradable films of Examples 1 to 3 all had a haze of 3% or less, indicating excellent transparency, whereas the single-layer or multi-layer biodegradable films of Comparative Examples 1 to 3 and 5 had a haze exceeding about 3%, in particular, the single-layer biodegradable film of Comparative Example 2 had a haze of 25%, indicating that the transparency was significantly reduced.

Accordingly, the multilayer biodegradable sheets and films of Examples 1 to 3 of the present invention had excellent biodegradability and very excellent uniformity of the first resin layers, whereby the uniformity, flexibility, noise level, transparency, and appearance characteristics of a final film are excellent. They can be used in an environmentally friendly manner for a variety of purposes, including packaging for food.

### EXPLANATION OF REFERENCE NUMERALS

100: multilayer biodegradable film
110: first resin layer (individual layer)
110′: outermost layers on both sides
120: second resin layer (individual layer)
N: a point 50 mm away from one end in the transverse direction of a multilayer biodegradable film
C: a central point in the transverse direction of a multilayer biodegradable film
S: a point 50 mm away from the other end in the transverse direction of a multilayer biodegradable film
W: width
W1: width away from one end of a multilayer biodegradable film
W2: width away from the other end of a multilayer biodegradable film
L: length
A-A′: cut line

1. A multilayer biodegradable film, which comprises two or more different thermoplastic resin layers alternately laminated, wherein the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUI) of the first resin layers, represented by the following Equation 1, is 0.2 μm or less:
$$L U I ( µm ) = \frac{\begin{matrix}( {t}_{m ax , N} - {t}_{m i n , N} ) + ( {t}_{ma x , C} - \\ {t}_{m i n , C} ) + ( {t}_{ma x , S} - {t}_{m i n , S} )\end{matrix}}{3} \qquad < Equation 1 >$$
in Equation 1, when the multilayer biodegradable film having a width of 500 mm and a thickness of 20 to 25 m is cut in the thickness direction along a point (N) 50 mm away from one end in the transverse direction, a point (S) 50 mm away from the other end in the transverse direction, and a central point (C) in the transverse direction, and when the thicknesses of the individual layers, excluding the outermost layers on both sides, of the laminated first resin layers are measured using a field emission scanning electron microscope (FE-SEM) on the cross-section,
t_{max, N} is the maximum thickness of the thicknesses of the individual layers, excluding the outermost layers on both sides, of the first resin layers measured at point N of the multilayer biodegradable film,
t_{min, N} is the minimum thickness of the thicknesses of the individual layers, excluding the outermost layers on both sides, of the first resin layers measured at point N of the multilayer biodegradable film,
t_{max, S} is the maximum thickness of the thicknesses of the individual layers, excluding the outermost layers on both sides, of the first resin layers measured at point S of the multilayer biodegradable film,
t_{min, S} is the minimum thickness of the thicknesses of the individual layers, excluding the outermost layers on both sides, of the first resin layers measured at point S of the multilayer biodegradable film,
t_{max, C} is the maximum thickness of the thicknesses of the individual layers, excluding the outermost layers on both sides, of the first resin layers measured at point C of the multilayer biodegradable film, and
t_{min, C} is the minimum thickness of the thicknesses of the individual layers, excluding the outermost layers on both sides, of the first resin layers measured at point C of the multilayer biodegradable film.

2. The multilayer biodegradable film of claim 1, wherein the difference in uniformity (Δt_{N,S}) in the transverse direction of the multilayer biodegradable film, represented by the following Equation 2, is 0.06 m or less:
$$Δ {t}_{N , S} ( µm ) = \vert ( {t}_{ma x , N} - {t}_{m i n , N} ) - ( {t}_{m ax , S} - {t}_{m i n , S} ) \vert . \qquad < Equation 2 >$$

3. The multilayer biodegradable film of claim 1, wherein the flexible noise complexity (FNC), represented by the following Equation 3, is 20 or less:
$$F N C = \frac{Y M \times {N}_{A V G}}{1000} \qquad < Equation 3 >$$
in Equation 3, YM and N_{AVG} are values, excluding units, measured with a specimen of the multilayer biodegradable film, respectively,
when a specimen of the multilayer biodegradable film is prepared, cut to a size of 150 mm in length and 15 mm in width, mounted with a spacing between chucks of 50 mm, and tested at a tensile speed of 200 mm/minute according to ASTM D882, YM is Young's modulus (kgf/mm²) as a slope of the straight line between the starting point of measurement and an elongation of 3%, and
when the multilayer biodegradable film is cut to a size of A4, 210 mm×297 mm, and placed 30 cm away from a digital noise analyzer in a box of 650 (W) mm×450 (D) mm×500 (H) mm made of a polycarbonate, and both ends of the film are held with jigs and repeatedly twisted back and forth at a speed of 30 times/minute to make noise for more than 5 seconds, N_{AVG} is an average noise level (dB) of 5 measurements thereof.

4. The multilayer biodegradable film of claim 3, wherein the apparent noise quality composite index (QCI) of the film, represented by the following Equation 4, is 28 or less:
$$Q C I = \frac{H Z + L U I + {N}_{AVG}}{3} \qquad < Equation 4 >$$
in Equation 4, HZ, LUI, and N_{AVG} are values, excluding units, measured with a specimen of the multilayer biodegradable film, respectively, and HZ is the haze (%) of the multilayer biodegradable film.

5. The multilayer biodegradable film of claim 1, wherein the outermost layers on both sides of the film are each the first resin layer, and the sum of the thicknesses of the outermost layers on both sides is 5 to 40% of the total thickness of the film.

6. The multilayer biodegradable film of claim 1, wherein the film has 5 layers or more, and the average thickness ratio of individual layers of the first resin layers and the second resin layers, excluding the outermost layers on both sides, is 1:0.5 to 2.

7. The multilayer biodegradable film of claim 1, wherein the content of the aliphatic component among the acid components in the aliphatic-aromatic copolymerized polyester-based resin is 30% by mole or more.

8. A multilayer biodegradable sheet, which comprises two or more different thermoplastic resin layers alternately laminated, wherein the thermoplastic resin layers comprise a first resin layer comprising a polylactic acid-based polymer as a main component and a second resin layer comprising an aliphatic polyester-based resin or an aliphatic-aromatic copolymerized polyester-based resin as a main component, and the uniformity (LUIₛ) of the first resin layers, represented by the following Equation 1-1, is less than 2.3 μm:
$$L U Is ( µm ) = \frac{\begin{matrix}( {t}_{m ax , N 1} - {t}_{m i n , N 1} ) + ( {t}_{m ax , C 1} - \\ {t}_{m i n , C 1} ) + ( {t}_{m ax , S 1} - {t}_{m i n , S 1} )\end{matrix}}{3} \qquad < Equation 1 - 1 >$$
in Equation 1-1, when the multilayer biodegradable sheet having a width of 650 mm and a thickness of 300 m is cut in the thickness direction at a point 50 mm away from one end in the transverse direction (N), a point 50 mm away from the other end in the transverse direction (S), and a central point (C) in the transverse direction, and when the thickness of the individual layer, excluding the outermost layers on both sides, of the laminated first resin layers is measured using a field emission scanning electron microscope (FE-SEM) on the cross-section,
t_{max, N1} is the maximum thickness of the thicknesses of the individual layers, excluding the outermost layers on both sides, of the first resin layers measured at point N of the multilayer biodegradable sheet,
t_{min, N1} is the minimum thickness of the thicknesses of the individual layers, excluding the outermost layers on both sides, of the first resin layers measured at point N of the multilayer biodegradable sheet,
t_{max, S1} is the maximum thickness of the thicknesses of the individual layers, excluding the outermost layers on both sides, of the first resin layers measured at point S of the multilayer biodegradable sheet,
t_{min, S1} is the minimum thickness of the thicknesses of the individual layers, excluding the outermost layers on both sides, of the first resin layers measured at point S of the multilayer biodegradable sheet,
t_{max, C1} is the maximum thickness of the thicknesses of the individual layers, excluding the outermost layers on both sides, of the first resin layers measured at point C of the multilayer biodegradable sheet, and
t_{min, C1} is the minimum thickness of the thicknesses of the individual layers, excluding the outermost layers on both sides, of the first resin layers measured at point C of the multilayer biodegradable sheet.

9. A process for preparing a multilayer biodegradable film, which comprises:
preparing a first resin comprising a polylactic acid-based polymer as a main component and a second resin comprising an aliphatic polyester-based resin or an aliphatic-aromatic copolymerized polyester-based resin as a main component, respectively (step 1);
melt-extruding the first resin and the second resin, respectively, and alternately laminating a first resin layer and a second resin layer to obtain a sheet in which two or more different types of thermoplastic resin layers are alternately laminated (step 2); and
biaxially stretching and heat setting the laminated sheet to obtain a multilayer biodegradable film (step 3),
wherein the uniformity (LUI) of the first resin layers in the multilayer biodegradable film, represented by the following Equation 1, is 0.2 μm or less:
$$L U I ( µm ) = \frac{\begin{matrix}( {t}_{ma x , N} - {t}_{m i n , N} ) + ( {t}_{m ax , C} - \\ {t}_{m i n , C} ) + ( {t}_{m ax , S} - {t}_{m i n , S} )\end{matrix}}{3} \qquad < Equation 1 >$$
in Equation 1, when the multilayer biodegradable film having a width of 500 mm and a thickness of 20 to 25 m is cut in the thickness direction along a point (N) 50 mm away from one end in the transverse direction, a point (S) 50 mm away from the other end in the transverse direction, and a central point (C) in the transverse direction, and when the thicknesses of the individual layers, excluding the outermost layers on both sides, of the laminated first resin layers are measured using a field emission scanning electron microscope (FE-SEM) on the cross-section,
t_{max, N} is the maximum thickness of the thicknesses of the individual layers, excluding the outermost layers on both sides, of the first resin layers measured at point N of the multilayer biodegradable film,
t_{min, N} is the minimum thickness of the thicknesses of the individual layers, excluding the outermost layers on both sides, of the first resin layers measured at point N of the multilayer biodegradable film,
t_{max, S} is the maximum thickness of the thicknesses of the individual layers, excluding the outermost layers on both sides, of the first resin layers measured at point S of the multilayer biodegradable film,
t_{min, S} is the minimum thickness of the thicknesses of the individual layers, excluding the outermost layers on both sides, of the first resin layers measured at point S of the multilayer biodegradable film,
t_{max, C} is the maximum thickness of the thicknesses of the individual layers, excluding the outermost layers on both sides, of the first resin layers measured at point C of the multilayer biodegradable film, and
t_{min, C} is the minimum thickness of the thicknesses of the individual layers, excluding the outermost layers on both sides, of the first resin layers measured at point C of the multilayer biodegradable film.

10. The process for preparing a multilayer biodegradable film of claim 9, wherein the melt viscosity of the first resin layer is greater than the melt viscosity of the second resin layer.

11. The process for preparing a multilayer biodegradable film of claim 9, wherein the interlayer melt viscosity difference (ΔV) at 210° C., represented by the following Equation 5, is 500 poise or more:
$$Δ V = V 1 - V 2 \qquad < Equation 5 >$$
in Equation 5, V1 is the melt viscosity of the first resin layer, and V2 is the melt viscosity of the second resin layer.

12. The process for preparing a multilayer biodegradable film of claim 9, wherein the difference between the melt extrusion temperature of the first resin and the melt extrusion temperature of the second resin is less than 30° C.

13. The process for preparing a multilayer biodegradable film of claim 9, wherein the melt extrusion temperature of the first resin is higher than 180° C. to 250° C., and the melt extrusion temperature of the second resin is higher than 180° C. to 250° C.

14. An environmentally friendly packaging material, which comprises the multilayer biodegradable film of claim 1.
